(19) United States
(12) Patent Application Publication
(10) Pub. No.: US 2017/0255820 A1
(43) Pub. Date: Sep. 7, 2017

(54) IDENTIFICATION OF INDIVIDUALS IN IMAGES AND ASSOCIATED CONTENT DELIVERY

(71) Applicant: Jiwen Liu, Foster City, CA (US)

(72) Inventor: Jiwen Liu, Foster City, CA (US)

(21) Appl. No.: 15/510,983

(22) PCT Filed: Sep. 16, 2015
(86) PCT No.: PCT/US2015/050459

§ 371 Date: Mar. 13, 2017

Related U.S. Application Data
(60) Provisional application No. 62/051,068, filed on Sep. 16, 2014.

(51) Int. Cl. G06K 9/00; H04N 5/225; G06F 17/40; H04N 5/262; H04Q 5/22; G06F 21/60; G06F 15/16; G06F 17/30

(52) U.S. Cl. CPC G06K 9/00288; G06K 9/00677; G06F 15/16; H04N 5/225; G06F 17/30; H04N 5/262; H04Q 5/22; G06F 21/60; G06F 17/40; G06K 2009/00328; G06K 2209/27

(57) ABSTRACT

Techniques are provided that may be generally associated with content and media, such as digital photos or videos from events. Techniques are provided, for example, relating to creating, identifying, identifying one or more individuals in, selecting, characterizing, obtaining, providing, storing, organizing or searching such content or media or elements thereof. Digital photos or video, for example, may be taken prior to or after an event, in which RFID or barcode technology is used in obtaining metadata associated with the images that may include identification information regarding individuals in the photos. Facial recognition or appearance recognition technology may be used in identifying individuals in digital photos or video taken at events, and may be made available to individuals or accounts. Techniques are also provided that include use of RFID technology, and may include enhancements thereto, to identify individuals in digital photos or videos taken at events from RFID tags.

### PRIORITY APPLICATION

This application claims priority to U.S. Provisional Application No. 62/051,068, filed on Sep. 16, 2014, entitled, “ADDITION TO MEMORY INFORMATION COLLECTOR AND ORGANIZER (MICO)”.

### BACKGROUND

People cherish their memories. These may include events, such as may be shared with family, friends or other groups, including vacations, weddings, special events, ceremonies, graduations, social or work events or activities, concerts, sports events, etc. Furthermore, for example, content or media from such events, including, for example, digital photos, videos, etc., can be desired, meaningful and valued once obtained.

### SUMMARY

Some embodiments of the invention are generally associated with content and media, such as digital photos and video, for example, from events. Some embodiments relate to such things as creating, identifying, identifying one or more individuals in, selecting, characterizing, obtaining, providing, storing, organizing or searching such content or media or elements thereof, for example. For example, methods, systems, devices and computer readable media may be provided in this regard.

Some embodiments of the invention use RFID technology and/or barcode technology, along with facial recognition and/or appearance recognition technology. In some embodiments, RFID technology or barcode technology is utilized in obtaining and storing images, such as prior to or after an event, as well as metadata associated with the images, such as information about the identities of persons in the images. Images taken at the event, as well as before or after the event, may be analyzed using techniques including facial recognition or appearance recognition technology and persons in the images may be identified, or partly identified, with some degree of security-related or privacy-related limitations. Images may be selected and electronically delivered or made available to individuals, such as individuals identified in the images. This can include use of an one or more applications or “apps”, or one or more mobile “apps”, to wirelessly send to, make items available to, or communicate with devices or mobile devices of the individuals, such as shortly after the event, for example. In some embodiments, individuals may be able to select, review, view, download and make purchases of or including images or videos, such as may include them, their families, friends or groups, etc. In some embodiments, images may be uploaded, such as to accounts of individuals, such as to an online platform that may allow such activities as storage, collection, organization, creations, modification, search and retrieval of content or media.

Some embodiments include use of RFID technology to identify individuals, for example, in digital photos or digital videos taken at events, from RFID tags worn by or carried by individuals when content or media are obtained of the individuals at the events, such as when photos or videos are taken at the events that include the individuals. Some embodiments use various additional techniques, additions, modifications or enhancements to RFID techniques, for example, to aid in the practicality or effectiveness of its use according to embodiments of the invention. For example, this may include, among other things, staging or planning settings and directional layouts, power control, active RFID tags, UWB RFID technology or SAW RFID technology, UHF or microwave frequency communications, or special antenna technologies.

### BRIEF DESCRIPTION OF THE DRAWINGS

FIG. 1 illustrates a block diagram of a distributed computer system that can implement one or more aspects of an system or method according to one embodiment of the invention;

FIG. 2 illustrates a block diagram of an electronic device that can implement one or more aspects of a system or method according to one embodiment of the invention; and

FIGS. 3-11 illustrate flow diagrams of example operations of one or more aspects of a system or method according to one embodiment of the invention.

While the invention is described with reference to the above drawings, the drawings are intended to be illustrative, and the invention contemplates other embodiments within the spirit of the invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

Some embodiments of the invention use facial recognition technology or software, and some embodiments use appearance recognition technology (ART) or software. As the term is used herein, ART uses not only traditional facial features (relatively unchanging over time, generally used in traditional facial recognition, which can include, for example, characteristics, geometry, and shape of the heads, face, eyes, nose, mouth, cheeks, chin or ears, and/or portions, elements, and/or aspects thereof, and/or distances or relative distances associated with or between such features or elements thereof), but also one or more non-traditional facial features or other appearance characteristics. In some embodiments, such non-traditional features or characteristics can include, for example, among other things, hair style, facial hair or style, makeup, eyeglasses, hair, clothing, pants, shirts, hats, shoes, jewelry, earrings, body height, body size, and/or tattoos.

Herein, “content” can broadly include, for example, among other things, photographs, images, video, and audio, among other things. Furthermore, “images” can broadly include, for example, among other things, photographs, and portions or snapshots of video.

In some embodiments of the invention in which appearance recognition technology (discussed further below) is utilized, images may not need to include even part of the face of an individual. For example, in some embodiments, images, such as images taken at an event, can be analyzed to identify an individual based on appearance factors other than face-related ones, such as clothing, for example.

According to various embodiments, techniques, systems, methods, devices, apparatuses and computer-readable media may be provided, such as non-transitory computer readable storage medium tangibly storing computer program instructions capable of being executed by a computer processor.

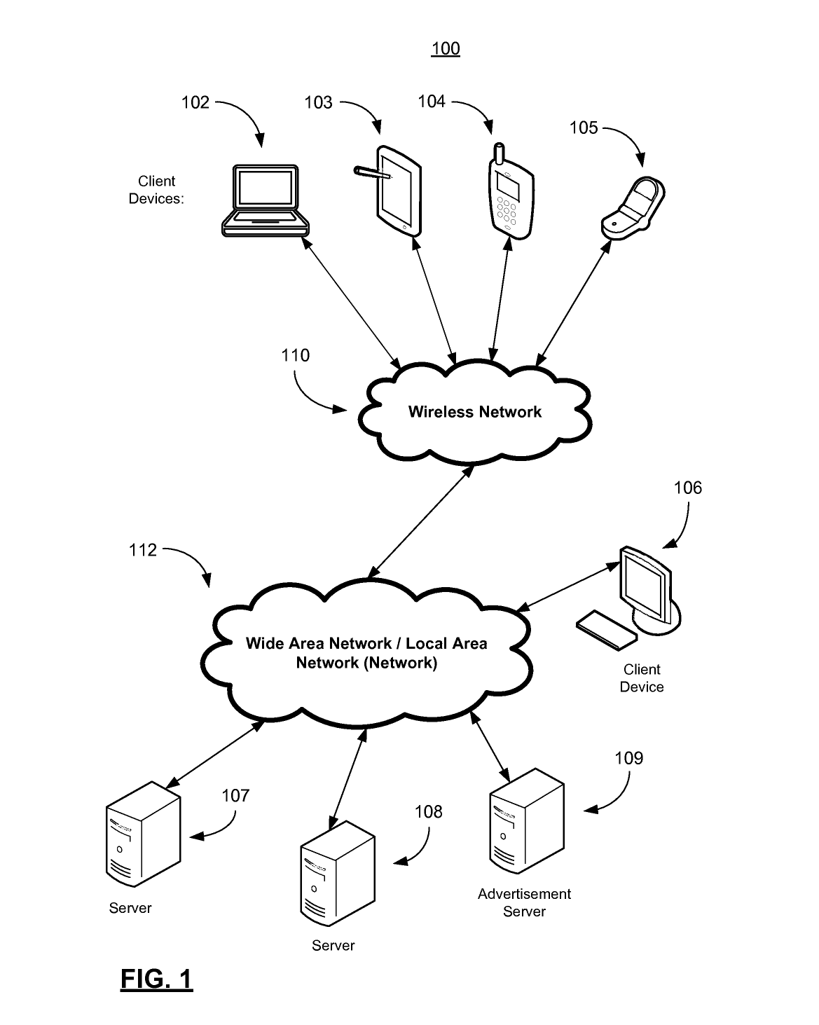

FIG. 1 illustrates components of one embodiment of an environment in which the invention may be practiced. Not all of the components may be required to practice the invention, and variations in the arrangement and type of the components may be made without departing from the spirit or scope of the invention. While not depicted in FIG. 1, embodiments of the invention anticipate use of RF (Radio Frequency) and RFID (Radio Frequency Identification) technology, equipment, devices, apparatuses, systems, methods and techniques, as well as modification, additions, or enhancements thereto, as may be described herein. This can include, for example, RF devices such as active, passive and semi-passive tags, receivers, transmitters, antennas, etc., as known in the art, as well as modification or enhancements thereto as may be described herein.

As shown, the system 100 includes one or more local area networks (“LANs”)/wide area networks (“WANs”) 112, one or more wireless networks 110, one or more wired or wireless client devices 106, mobile or other wireless client devices 102-106, servers 107-108 and one or more advertisement servers 109, and may include or communicate with one or more data stores or databases. Various of the client devices 102-106 may include, for example, desktop computers, laptop computers, set top boxes, tablets, cell phones, smart phones, etc. The servers 107-109 can include, for example, one or more application servers, content servers, search servers, etc.

An advertisement server can include, for example, a computer server that has a role in connection with online advertising, such as, for example, in obtaining, storing, determining, configuring, selecting, ranking, retrieving, targeting, matching, serving and presenting online advertisements to users, such as on websites, in applications, and other places where users will see them.

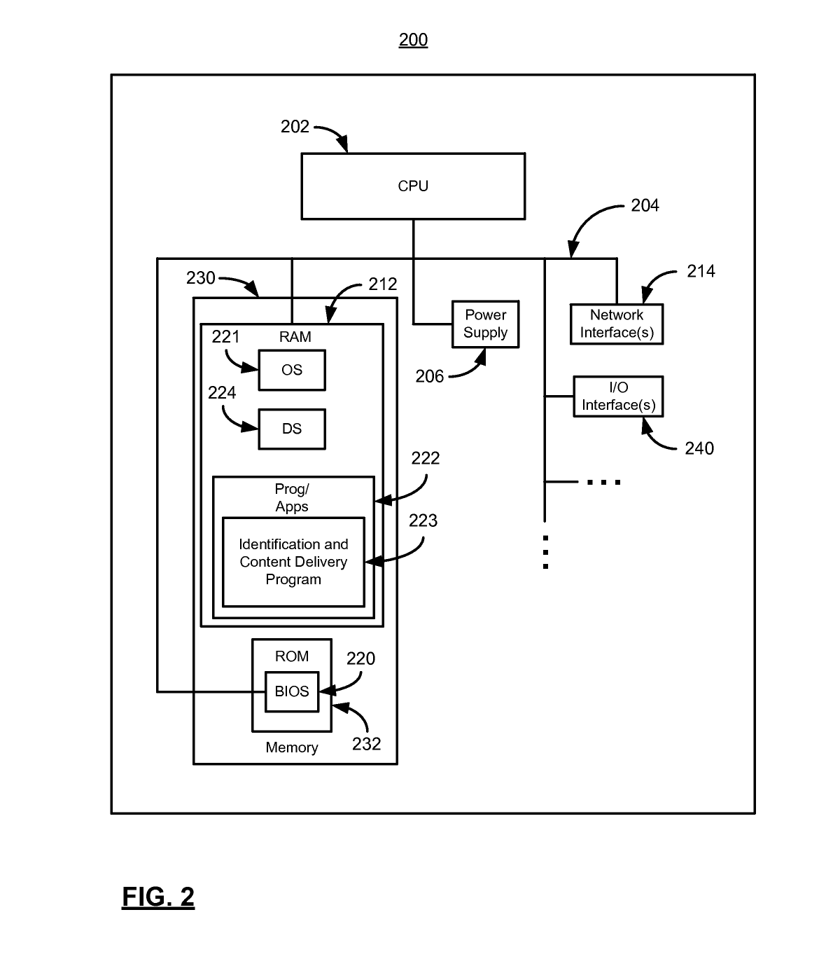

FIG. 2 illustrates a block diagram of an electronic device 200 that can implement one or more aspects of an RFID-facilitated system or method according to one embodiment of the invention. Instances of the electronic device 200 may include servers, e.g. servers 107-109, and client devices, e.g. client devices 102-106. In general, the electronic device 200 can include a processor 202, memory 230, a power supply 206, and input/output (I/O) components 240, e.g., microphones, speakers, displays, touchscreens, keyboards, keypads, GPS components, etc., which may be operable, for example, to provide graphical user interfaces. The electronic device 200 can also include a communications bus 204 that connects the aforementioned elements of the electronic device 200. Network interfaces 214 can include a receiver and a transmitter (or transceiver), and an antenna for wireless communications.

The processor 202 can include one or more of any type of processing device, e.g., a central processing unit (CPU). Also, for example, the processor can be central processing logic. Central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software controlled microprocessor, discrete logic, e.g., an application specific integrated circuit (ASIC), a programmable/programmed logic device, memory device containing instructions, etc., or combinatorial logic embodied in hardware. Furthermore, logic may also be fully embodied as software.

The memory 230, which can include RAM 212 and ROM 232, can be enabled by one or more of any type of memory device, e.g., a primary (directly accessible by the CPU) or secondary (indirectly accessible by the CPU) storage device (e.g., flash memory, magnetic disk, optical disk). The RAM can include an operating system 221, data storage 224, which may include one or more databases, and programs and/or applications 222, which can include, for example, software aspects of the RFID-Facilitated Identification and Content Delivery Program 223. The ROM 232 can also include BIOS 220 of the electronic device.

The RFID-Facilitated Identification and Content Delivery Program 223 is intended to broadly include or represent all programming, applications, algorithms, software and other tools necessary to implement or facilitate methods and systems according to embodiments of the invention. The elements of the RFID-Facilitated Identification and Content Delivery Program 223 may exist on a single server computer or be distributed among multiple computers or devices or entities, which can include advertisers, publishers, data providers, etc. Other elements according to embodiments of the invention, whether or not part of the Program 223, can include (or can include other) devices, apparatuses, hardware, etc.

The power supply 206 contains one or more power components, and facilitates supply and management of power to the electronic device 200.

The input/output components, including I/O interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, and one or more input/output interfaces. A network care, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the RFID-Facilitated Identification and Content Delivery Program, via a network to another device. Also, an application server may, for example, host a Web site that can provide a user interface for administration of example aspects of the RFID-Facilitated Identification and Content Delivery Program.

Any computing device capable of sending, receiving, and processing data over a wired and/or a wireless network may act as a server, such as in facilitating aspects of implementations of the Program. Thus, devices acting as a server may include devices such as dedicated rack-mounted servers, desktop computers, laptop computers, set top boxes, integrated devices combining one or more of the preceding devices, etc.

Servers may vary in widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, etc.

A server may include, for example, a device that is configured, or includes a configuration, to provide data or content via one or more networks to another device, such as in facilitating aspects of an example RFID-Facilitated Identification and Content Delivery Program. One or more servers may, for example, be used in hosting a Web site. One or more servers may host a variety of sites, such as, for example, business sites, informational sites, social networking sites, educational sites, wikis, financial sites, government sites, personal sites, etc.

Servers may also, for example, provide a variety of services, such as Web services, third-party services, audio services, video services, email services, instant messaging (IM) services, SMS services, MMS services, FTP services, voice or IP (VOIP) services, calendaring services, phone services, advertising services etc., all of which may work in conjunction with example aspects of an example RFID-Facilitated Identification and Content Delivery Programs. Content may include, for example, text, images, audio, video, advertisements, etc.

In example aspects of the RFID-Facilitated Identification and Content Delivery Program, client devices may include, for example, any computing device capable of sending and receiving data over a wired and/or a wireless network. Such client devices may include desktop computers as well as portable devices such as cellular telephones, smart phones, display pagers, radio frequency (RF) devices, infrared (IR) devices, Ultra-Wide Band (UWB) devices, UHF (Ultra-High Frequency) devices, Personal Digital Assistants (PDAs), handheld computers, GPS-enabled devices tablet computers, sensor-equipped devices, laptop computers, set top boxes, wearable computers, integrated devices combining one or more of the preceding devices, etc.

Client devices, as may be used in example Programs, may range widely in terms of capabilities and features. For example, a cell phone, smart phone or tablet may have a numeric keypad and a few lines of monochrome LCD display on which only text may be displayed. In another example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 102-106, for example, as may be used in example RFID-Facilitated Identification and Content Delivery Programs, may run a variety of operating systems, including personal computer operating systems such as Windows, iOS or Linux, and mobile operating systems such as iOS, Android, and Windows Mobile, etc. Client devices may be used to run one or more applications that are configured to send or receive data from another computing device. Client applications may provide and receive textual content, multimedia information, etc. Client applications may perform actions such as browsing webpages, using a web search engine, sending and receiving messages via email, SMS, or MMS, playing games (such as fantasy sports leagues), receiving advertising, watching locally stored or streamed video, or participating in social networks.

In example aspects of the RFID-Facilitated Identification and Content Delivery Program, one or more networks, such as networks 110 or 112, for example, may couple servers and client devices with other computing devices, including through wireless network to client devices. A network may be enabled to employ any form of computer readable media for communicating information from one electronic device to another. A network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and a telephone link.

A wireless network, such as wireless network 110, as in an example RFID-Facilitated Identification and Content Delivery Program, may couple devices with a network. A wireless network may employ stand-alone ad-hoc networks, mesh networks, Wireless LAN (WLAN) networks, cellular networks, etc.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, etc. Access technologies such as 2G, 2.5G, 3G, 4G, and future access networks may enable wide area coverage for client devices, such as client devices with various degrees of mobility. For example, wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, etc. A wireless network may include virtually any wireless communication mechanism by which information may travel between client devices and another computing device, network, etc.

Internet Protocol may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), wide area networks (WANs), wireless networks, and long haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site

A “content delivery network” or “content distribution network” (CDN), as may be used in an example RFID-Facilitated Identification and Content Delivery Program, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A peer-to-peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Some embodiments include direct or indirect use of social networks and social network information, such as in targeted advertising or advertisement selection. A “Social network” refers generally to a network of acquaintances, friends, family, colleagues, and/or coworkers, and potentially the subsequent connections within those networks. A social network, for example, may be utilized to find more relevant connections for a variety of activities, including, but not limited to, dating, job networking, receiving or providing service referrals, content sharing, creating new associations or maintaining existing associations with like-minded individuals, finding activity partners, performing or supporting commercial transactions, etc.

A social network may include individuals with similar experiences, opinions, education levels and/or backgrounds, or may be organized into subgroups according to user profile, where a member may belong to multiple subgroups. A user may have multiple “1:few” circles, such as their family, college classmates, or coworkers.

A person's online social network includes the person's set of direct relationships and/or indirect personal relationships. Direct personal relationships refers to relationships with people the user communicates with directly, which may include family members, friends, colleagues, coworkers, and the like. Indirect personal relationships refers to people with whom a person has not had some form of direct contact, such as a friend of a friend, or the like. Different privileges and permissions may be associated with those relationships. A social network may connect a person with other people or entities, such as companies, brands, or virtual persons. A person's connections on a social network may be represented visually by a “social graph” that represents each entity as a node and each relationship as an edge.

Users may interact with social networks through a variety of devices. Multi-modal communications technologies may enable consumers to engage in conversations across multiple devices and platforms, such as cell phones, smart phones, tablet computing devices, personal computers, televisions, SMS/MMS, email, instant messenger clients, forums, and social networking sites (such as Facebook, Twitter, and Google+), or others.

In some example RFID-Facilitated Identification and Content Delivery Program, various monetization techniques or models may be used in connection with contextual or non-search related advertising, as well as in sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking Bids may be associated with amounts the advertisers pay for certain specified occurrences, such as for placed or clicked-on advertisements, for example. Advertiser payment for online advertising may be divided between parties including one or more publishers or publisher networks, and one or more marketplace facilitators or providers, potentially among other parties.

Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics.

The process of buying and selling online advertisements may include or require the involvement of a number of different entities, including advertisers, publishers, agencies, networks, and developers. To simplify this process, some companies provide mutual organization systems called “ad exchanges” that connect advertisers and publishers in a unified platform to facilitate the bidded buying and selling of online advertisement inventory from multiple ad networks. “Ad networks” refers to companies that aggregate ad space supply from publishers and provide en masse to advertisers.

For Web portals, advertisements may be displayed on web pages resulting from a user-defined search based upon one or more search terms. Such advertising is most beneficial to users, advertisers and web portals when the displayed advertisements are relevant to the web portal user's interests. Thus, a variety of techniques have been developed to infer the user's interests/intent and subsequently target the most relevant advertising to that user.

One approach to improving the effectiveness of presenting targeted advertisements to those users interested in receiving product information from various sellers is to employ demographic characteristics (i.e., age, income, sex, occupation, etc.) for predicting the behavior of groups of different users. Advertisements may be presented to each user in a targeted audience based upon predicted behaviors rather than in response to certain keyword search terms.

Another approach is profile-based ad targeting. In this approach, user profiles specific to each user are generated to model user behavior, for example, by tracking each user's path through a web site or network of sites, and then compiling a profile based on what pages and advertisements were delivered to the user. Using aggregated data, a correlation develops between users in a certain target audience and the products that those users purchase. The correlation then is used to target potential purchasers by targeting content or advertisements to the user at a later time.

During the presentation of advertisements, the presentation system may collect detailed information about the type of advertisements presented to the user. This information may be used for gathering analytic information on the advertising or potential advertising within the presentation. A broad range of analytic information may be gathered, including information specific to the advertising presentation system. Advertising analytics gathered may be transmitted to locations remote to the local advertising presentation system for storage or for further analysis. Where such advertising analytics transmittal is not immediately available, the gathered advertising analytics may be saved by the advertising presentation system until the transmittal of those advertising analytics becomes available.

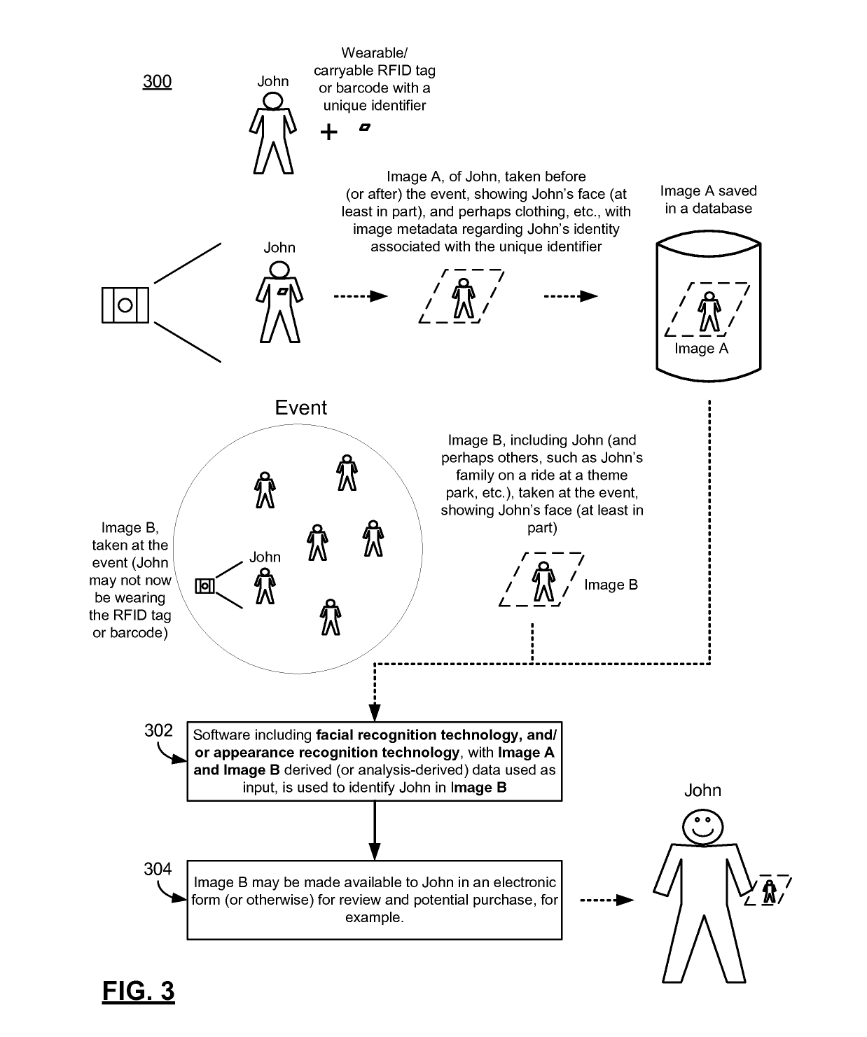

FIGS. 3-11 illustrate flow diagrams of example operations of one or more aspects of an RFID-facilitated system or method according to one embodiment of the invention.

As depicted in FIG. 3 300, an individual, John, is shown wearing or carrying an RFID tag with a unique RFID identifier or code. Although depicted in FIG. 3, in some embodiments, the RFID tag or barcode may be physical, electronic, just displayed electronically, etc. An image, Image A, is taken of John before (or after) an event, showing John's face (at least in part) and perhaps his clothing, other appearance factors, etc., along with image metadata regarding John's identity associated with the unique RFID identifier. The image and metadata are stored in a database.

At the event, image B is taken of John, such as a digital photo. At this point, John my not be wearing the RFID tag. Image B shows at least at least a portion of John's face, and may include others, such as John's family, friends, group, etc. For example, Image B could be an image of John and his family on a ride at an amusement park.

At step 302, Software including facial recognition technology, and/or appearance recognition technology, with Image A data (which can include data derived from image A or obtained from analysis of Image A) used as input, is used to identify John in Image B.

At step 304, Image B may be made available to John in an electronic form (or otherwise) for review and potential purchase, for example.

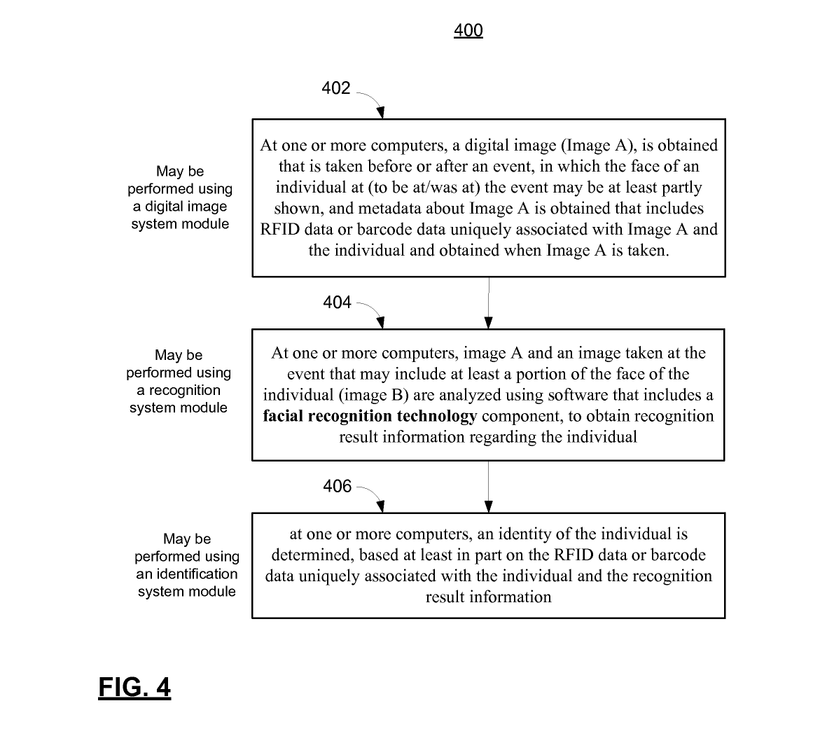

FIG. 4 depicts a flow diagram 400 according to an embodiment of the invention. In some embodiments, steps 402, 404 and 406 may be accomplished using a digital image module, recognition module, and identification module of the system, respectively.

At step 402, at one or more computers, a digital image (Image A), is obtained that is taken before or after an event, in which the face of an individual at (to be at/was at) the event is at least partly shown, and metadata about Image A is obtained that includes RFID data uniquely associated with Image A and with the individual (although, in some embodiments, the RFID data may be associated, or initially associated, with either only), in which the RFID data is wirelessly obtained from an RFID tag worn or carried by the individual when Image A is taken, or barcode data scanned from a barcode worn or carried by the individual when image A is taken.

At step 404, at one or more computers, image A and an image taken at the event and which may include at least a portion of the face of the individual (image B) is analyzed using software that includes a facial recognition technology component, to obtain recognition result information regarding the individual.

At step 406, at one or more computers, an identity of the individual is determined, based at least in part on the RFID data or the barcode data uniquely associated with the individual and the recognition result information.

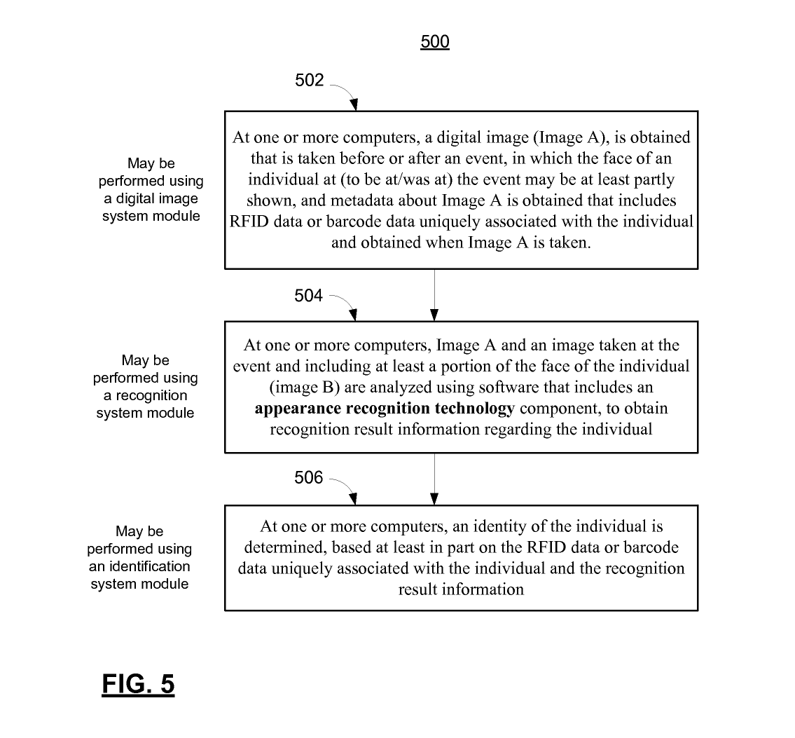

FIG. 5 depicts a flow diagram 500 according to an embodiment of the invention. Steps 502 and 506 are similar to steps 402 and 406 as depicted in FIG. 4. At step 504, at one or more computers, Image A and an image taken at the event that may include at least a portion of the face of the individual (image B) is analyzed using software that includes an appearance recognition technology component, to obtain recognition result information regarding the individual.

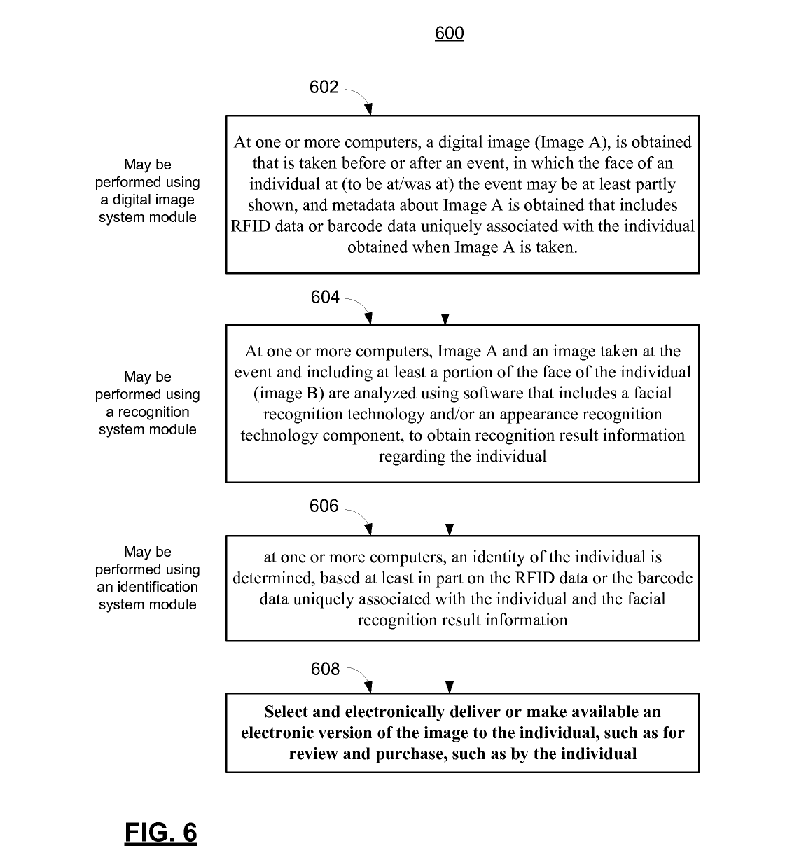

FIG. 6 depicts a flow diagram 600 according to an embodiment of the invention. Steps 602 and 606 are similar to steps 502 and 506 as depicted in FIG. 5. At step 604, at one or more computers, Image A and an image taken at the event and that may include at least a portion of the face of the individual (image B) is analyzed using software that includes a facial recognition technology and/or an appearance recognition technology component, to obtain recognition result information regarding the individual, which may include result information derived from facial recognition technology, result information derived from appearance recognition result technology, or both, result information derived from technology that includes aspects of both, etc.

Step 608 includes selecting and electronically delivering or making available an electronic version of the image to the individual, such as for review and purchase, such as by the individual. In some embodiments, this can include, for example, using a mobile “app”, which can have server-side elements and/or elements on a mobile device of the individual, for instance.

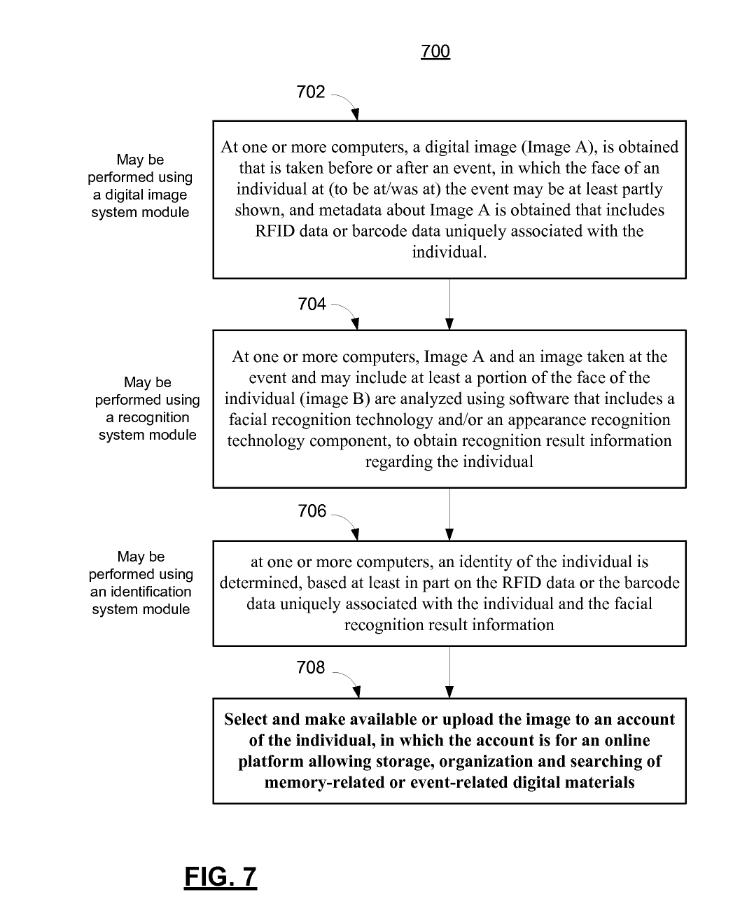

FIG. 7 depicts a flow diagram 700 according to an embodiment of the invention.

Steps 702-706 are similar to steps 602-606 as depicted in FIG. 6.

Step 708 includes Selection and making available or uploading the image to an account of the individual, in which the account is for an online platform allowing storage, organization and searching of memory-related or event-related digital materials.

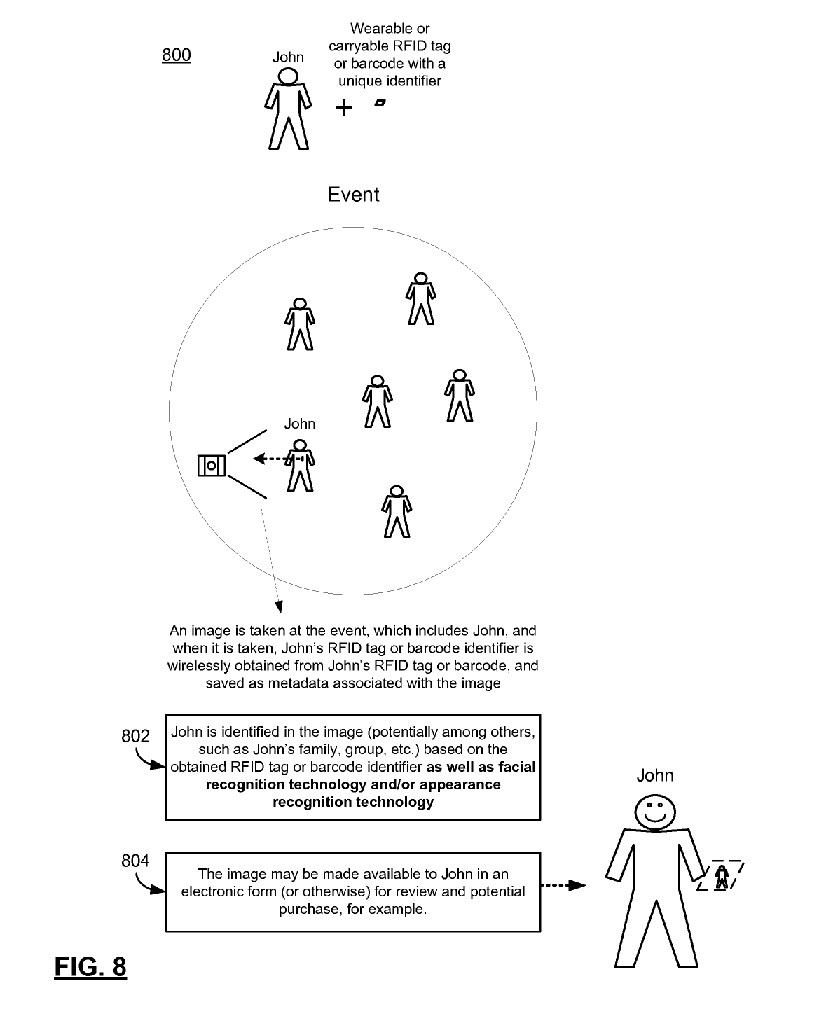

As depicted in FIG. 8 800, an individual, John, is shown wearing or carrying an RFID tag or barcode with a unique RFID or barcode identifier or code, while he is at an event. An image is taken at the event, which includes John (including at least a portion of John's face), and when it is taken, John's RFID tag identifier is wirelessly obtained from John's RFID tag, or John's barcode is read, and the identifying information is saved as metadata associated with the image. The image and metadata may be stored in a database.

At step 802, John is identified in the image (potentially among others, such as John's family, group, etc.) based on the obtained RFID tag identifier or barcode data as well as facial recognition technology and/or appearance recognition technology.

At step 804, the image may be made available to John in an electronic form (or otherwise) for review and potential purchase, for example.

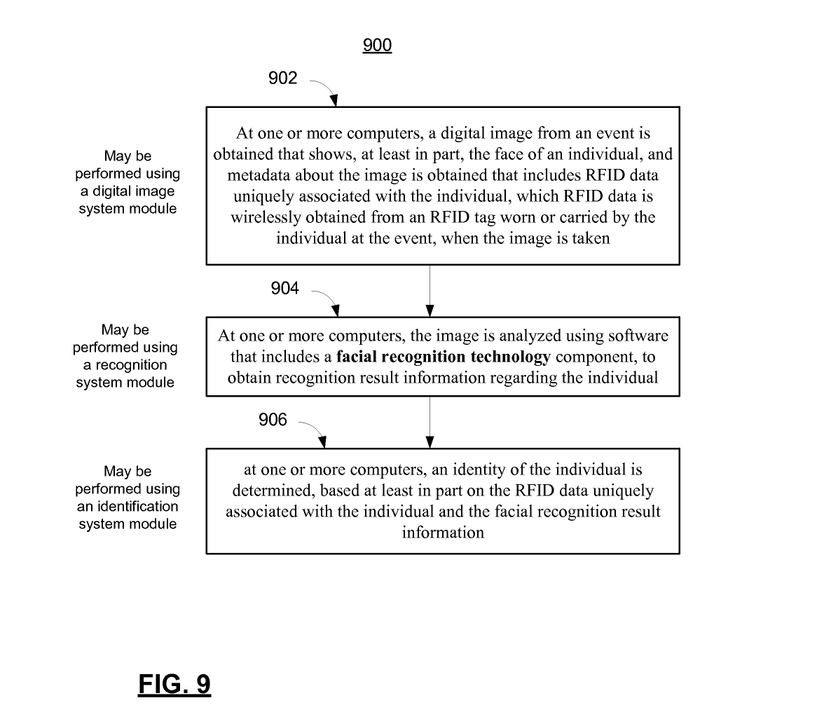

FIG. 9 depicts a flow diagram 900 according to an embodiment of the invention. In some embodiments, steps 902, 904 and 906 may be accomplished using a digital image module, recognition module, and identification module of the system, respectively.

At step 902, at one or more computers, a digital image from an event is obtained that may show, at least in part, the face of an individual, and metadata about the image is obtained that includes RFID data uniquely associated with the individual, which RFID data is wirelessly obtained from an RFID tag worn or carried by the individual at the event, when the image is taken,

At step 904, at one or more computers, the image is analyzed using software that includes a facial recognition technology component, to obtain recognition result information regarding the individual.

At step 906, at one or more computers, an identity of the individual is determined, based at least in part on the RFID data uniquely associated with the individual and the facial recognition result information.

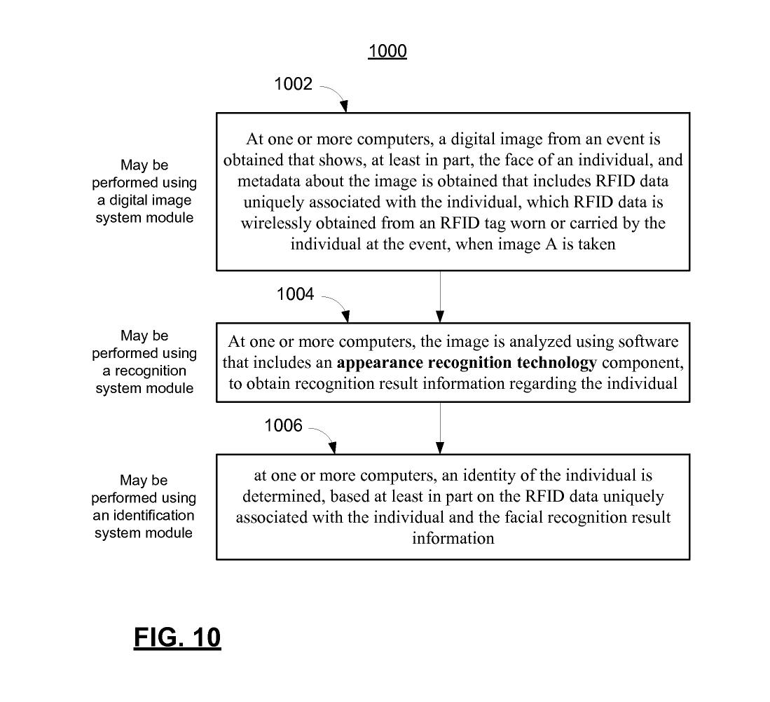

FIG. 10 depicts a flow diagram 1000 according to an embodiment of the invention.

Steps 1002 and 1006 are similar to step 902 and 906 as depicted in FIG. 9.

At step 1004, at one or more computers, the image is analyzed using software that includes an appearance recognition technology component, to obtain recognition result information regarding the individual.

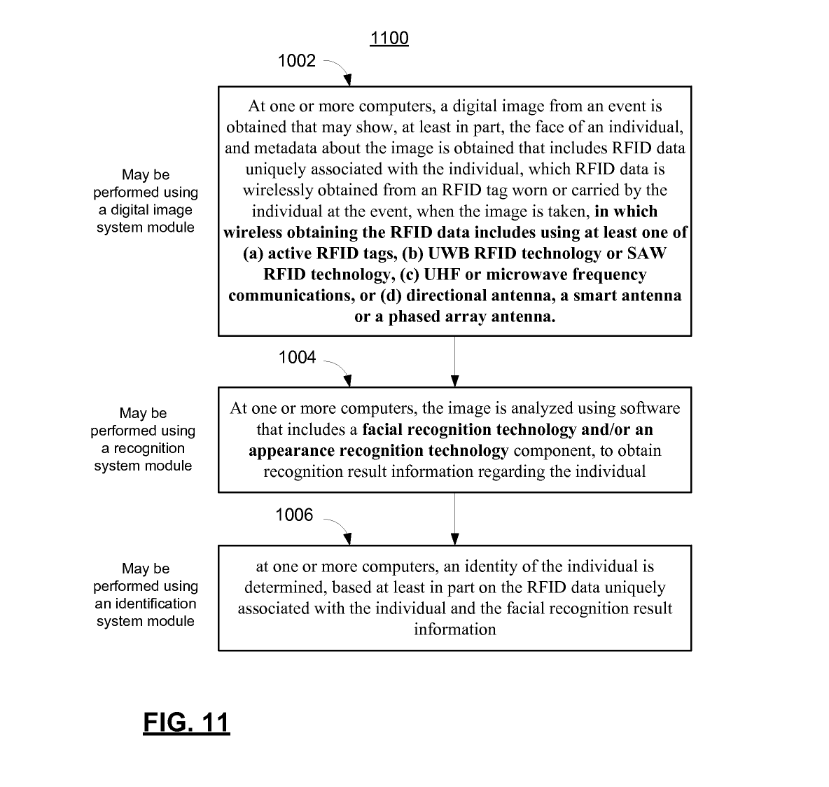

FIG. 11 depicts a flow diagram 1100 according to an embodiment of the invention. Step 1006 is similar to step 1006 as depicted in FIG. 10.

At step 1102, at one or more computers, a digital image from an event is obtained that shows, at least in part, the face of an individual, and metadata about the image is obtained that includes RFID data uniquely associated with the individual, which RFID data is wirelessly obtained from an RFID tag worn or carried by the individual at the event, when the image is taken, in which wireless obtaining the RFID data includes using at least one of (a) active RFID tags, (b) UWB RFID technology or SAW RFID technology, (c) UHF or microwave frequency communications, or (d) directional antenna, a smart antenna or a phased array antenna.

At step 1104, at one or more computers, the image is analyzed using software that includes a facial recognition technology and/or an appearance recognition technology component, to obtain recognition result information regarding the individual.

Some embodiments of the invention provide systems, devices, platforms and methods, for example, for identifying people in digital photos (videos) utilizes RFID (radio-frequency identification) technology and appearance recognition technology (ART) during digital photo taking and processing, which may herein be referred to as IDPHOTO. Herein, MICO can mean, for example, the system that enables Memory Information Collector and Organizer, its online platform, or its web and mobile app. In some embodiments, IDPHOTO can be used in combination with MICO.

In some embodiments, MICO can include technologies to collect, organize, safely store, and easily search memory related digital materials. For example, these materials may be related to graduation ceremonies, weddings, anniversaries, vacations, birthdays, concerts, ball games, conferences, etc. Digital photos and videos may be important forms of these materials. In some embodiments, even though MICO provides a unique way to collect, organize, store and search photos and videos, technologies can still be added, for example, to more accurately identify the people in photos and videos to enable more effective services (e.g., for MICO to more effectively collect right photos and deliver to right accounts). People are reading and watching more and more materials online. Some of these online materials may become important later, and people may want to read or watch them again. But it may be difficult to find the materials again simply through Google search of key words. People may remember the place, time, on what device, and weather etc. Taking advantage all these memories and using them to enhance the search will be beneficial.

This description is, for convenience and not limitation, generally divided into five sections. The first includes IDPHOTO and its connection with MICO. The second includes “Instant Awesome” and described herein. The third includes an expansion for the photo-sharing/delivering and photo market services of MICO. The fourth includes an embodiment of a good photo business in an amusement park. The fifth is for an expansion of MICO to collect, organize, store and search online (reading) materials. The descriptions of these sections is not intended to be limiting, and the sections are not intended to be viewed as separate, but can overlap and aspects can be used together in some embodiments.

### IDPHOTO

In some embodiments, RFID technology, appearance recognition technology (ART), or a combination of both may be used to accurately identify people in photos and videos. Some embodiments relate to accurately identify people taken in photos in various situations, but embodiments can also be applicable to videos and other digital media.

In an event such as, for example, wedding, birthday party, graduation, company sponsored activities, rides, etc., many photos are taken. However, these photos are not typically sorted and organized to make them conveniently available to people. People often are mainly interested in the photos in which they are a part of. However, they usually have to go through all the photos to find the photos in which they appeared. There has not been a sufficiently effective way that accurately sort and organize photos, before they are accurately delivered or shared (e.g. in a setting of photo-sharing/delivering service). It takes a lot time, and thus is not convenient to sort and organize the photos just by looking at them. If photos number large enough, such as, for example, thousands or more, it is not practical to sort and organize photos manually. An effective (automatic) way to sort and organize photos can enable better services (e.g. for photo-sharing/delivering), but this effective (automatic) way needs high accuracy to enable useful services (e.g. for photo-sharing/delivering). Two technologies (facial recognition and RFID) can be used to sort and organize photos, but both may have weaknesses or limitations which limit convenience and their use for accurately identifying people in photos in various situations.

Facial recognition (traditional) can be used to sort and organize photos (e.g. put together photos that belong to one person or family), and it requires a database of faces to do identification. It is not practical in many events to have a collection (database) of peoples' faces who would participate in the events. Without a database of faces and thus no identification of the people in photos, the sorted photos cannot be delivered to right people. Facial recognition technology is improving, but still has weakness for accurate sorting/organizing photos. Its accuracy can be affected by poor lighting, sunglasses, long hair, or other objects partially covering the subject's face, facial expression and low resolution images.

In some embodiments, RFID (radio-frequency identification) technology can also be used to identify the people in photos. If people in an event wear RFID tags (each person has a unique RFID), the cameras equipped with RFID readers (including antennas) can take photos and read the RFID of people, so that the digital photos are associated with RFID information (RFID metadata of photo) recorded during, before or after photo shooting. The RFID reader (device) equipped with (coupled to) camera can be physically attached to the camera, or function as a separate device. The communication between the RFID reader and the camera can be direct, if wired together (e.g. the reader and camera are attached), or go through wireless communication, such as using Bluetooth technology. Through the communication, the RFID metadata is associated with the digital photo. With RFID metadata, photos can be sorted and organized according to RFID, so that photos can be distributed to people who are in the photos using RFID.

In some embodiments, even though reading RFID can be done before or after photo shooting (reading RFID and photo shooting become two tasks), reading RFID at the same time as photo shooting is the more convenient and can be necessary in certain situations, such as fast moving rides in amusement parks, or fast moving people in activities, etc., because in these situations reading RFID not at the same time as photo-shooting is very difficult, if not impossible. However, current RFID technology also has weakness, or is not mature enough, which creates difficulty for building a cost efficient device (including RFID reader) coupled with camera that can accurately record RFID (capturing all the right RFID without recording wrong RFID, or capturing all the right RFID and separating wrong RFID) within the time frame of photo-shooting. In the following paragraphs, reading RFID at the same time as photo shooting will be described first, followed by separate reading of RFID (before or after photo shooting).

In some embodiments, it is desirable to use passive and semi-passive RFID tags, because their cost is low, so that they can be disposable. Active RFID tags may have to be reused (high cost), but they have the advantage of long reading range. UHF and microwave frequency probably need to be used when passive and semi-passive tags are used, because these frequencies can achieve enough reading range (e.g. >10 meter) to be useful in photo-taking. Surface acoustic wave (SAW) RFID tags can also be used to ensure sufficient reading range and performance. To accurately identify people in photos, all the people (their RFID) in photos need to be identified, and the RFID of people outside the photos should not be read, or can be separated if read. In some embodiments, in order to read the RFID of all the people in a photo, the reading range need to be sufficient, so RFID frequency (e.g. UHF and microwave) needs to be properly selected and RF signal power needs to be sufficient (within regulation limit). In addition, the RFID tag (antenna) orientation and angle for reading may need to be considered, and multiple tags on one person can significantly increase the chance of a properly positioned tag no matter what posture a person takes. In some embodiments, there are multiple ways to put RFID tags on people. For example, RFID tags can be embedded in name tags, wrist bands, necklaces, etc. to give to people to wear. If multiple tags are put in a wrist band, they can have different orientations and angles.

In some embodiments, in order to capture all the wanted RFID, sufficient RF signal power is needed for passive and semi-passive tags. Too much power most likely also reads the nearby unwanted RFID tags (e.g. those on people nearby but not in the photos). It is more complicated to avoid reading unwanted RFID tags than capturing all wanted tags. If RFID reader can avoid (or minimize) sending signal to unnecessary area, unwanted tags reading can be minimized. Use of narrow RF signal beam width (e.g. microwave frequency) can minimize reading the people on the side, and control of RFID power and thus the reading range can minimize reading the people who are behind the people taking picture. However, to make a RFID reader that can adjust beam width and reading range (power) according to camera viewfinder and focus range can be complicated and thus costly.

In some embodiments, if accurately controlling RFID signal area is difficult, detecting RFID tag's position in front of camera can be used to separate unnecessary RFID reading from the wanted RFID reading. Digital camera auto focus can detect the range of the target to camera. Detecting position of RFID tag (e.g. through RF time-of-flight and direction-of-arrival) includes detecting signal direction-of-arrival and range. The range detected through RFID technology can be compared to auto focus range (of camera) to tell the wanted RFID from the unwanted RFID that are out of the right range. The signal direction-of-arrival can be used to tell unwanted RFID tags on the side. Capability of different RFID technologies varies for detecting the position of RFID tag. Ultrawide Bandwidth RFID (UWB RFID) technology may be especially suitable for this purpose, because it can potentially provide very accurate detection of the range of RFID tag (through RF time-of-flight). However, some UWB RFID technology is not completely mature (e.g. for detecting position of the passive and semi-passive tags). RF direction-of-arrival may be used alone for separating unwanted RFID on the side, because the wanted RFID direction-of-arrival usually is about perpendicular to camera. To detect RF direction-of-arrival, special antennas (e.g. directional antennas, phased arrays and smart antennas) on RFID reader are needed.

In some embodiments, the RFID reader coupled with camera also requires sufficient data transfer/capture speed from RFID tags, in order to capture all the wanted RFID (e.g. 1 to 100 RFID) in the time frame of a single snapshot. Therefore, high frequency (e.g. UHF and microwave frequency) is preferred because they enable high data transfer speed.

In some embodiments, these RFID technologies (mentioned above) can be combined and achieve desired results of avoiding reading unnecessary RFID tags or separating unwanted RFID if read. However, the technologies may have weakness or need further development. To use them to build a RFID device (reader) for camera can be complicated and costly. On the other hand, a simple RFID reader (coupled to camera) that ensures capture of wanted RFID can be sufficient for identifying people in photos and/or delivering photos to the right people with some assistance.

In some embodiments, a simple RFID reader (coupled to camera) that ensures capture of wanted RFID is likely to capture unwanted RFID from time to time, so assistance may be needed to separate the unwanted RFID from the wanted ones, if advanced RFID technology is not used for the separation (e.g. determine the position of RFID tags, see above). In some embodiments, appearance recognition technology (ART), including traditional facial recognition technology, can be the most important assistance in many situations. In addition, in some embodiments, GPAR, group association, and time/location metadata of photos can also be the assistance to a degree. Description is provided below regarding different situations, such as for small or big events.

The paragraphs above describes reading RFID at the same time as photo shooting. In some embodiments, in many situations, RFID can be read right before or after photo shooting. Simultaneous reading of RFID (SiRR) with photo shooting can be necessary for certain situations, such as the fast moving rides of amusement parks, or fast moving people in activities, etc. Separate reading (before or after photo shooting) can ensure accurate reading of RFID (and avoid reading unwanted RFID), even though it becomes less convenient, since reading and photo shooting can become two tasks.

In some embodiments, separate reading of RFID (SeRR) readers (devices) coupled to cameras can be designed differently from SiRR readers to ensure accurate reading of RFID. SiRR readers (coupled to cameras) need to ensure capturing all wanted RFID, at the risk of capturing some unwanted RFID, as described above. Without sophisticated RFID technology (e.g. UWB RFID, SAW RFID), it can be hard to avoid capturing unwanted RFID or separate wanted RFID from unwanted. In some embodiments, to ensure capturing all wanted RFID, SiRR readers may need to have enough RF signal beam width and reading range (power) to cover the reading width and depth in front of cameras. Since SeRR readers capture RFID at a different time of photo shooting, photographers can take SeRR readers to a more desirable location to capture RFID. For example, photographers can move close to people, and point SeRR readers more accurately at RFID tags. Therefore, SeRR readers do not have to have as long reading range (e.g. <1 m can be sufficient) as SiRR readers, and they can have more narrow RF signal beam width, because photographers can point SeRR readers more accurately at RFID tags. Much lower reading power (range) and narrower beam width should significantly minimize unwanted RFID reading. SeRR readers can also be designed to read RFID by tapping RFID tag or at very short distance (e.g. using NFC technology). The speed of data transfer does not need to be high for SeRR readers, because they usually read one RFID at a time. SeRR readers can also have the ability to read barcodes (1D or 2D). Both SiRR and SeRR reader (device) can be designed to be physically attached to a camera, or a separate device. The communication between reader and camera can be wired or wireless (e.g. using Bluetooth). The communication ensures RFID metadata (ID information) is associated the corresponding digital photo. SiRR readers can have separated antennas (and multiple of them) to increase reading accuracy and range. Increasing antenna size and number, and putting them in good positions relative to RFID tags should increase reading accuracy and range.

In some embodiments, the SiRR reader and the SeRR reader (device) can be combined into one device (coupled to camera) with selection of power (reading range) and RF beam width, and antenna may be combined with the reader. For example, when higher power and wider beam width is chosen, the device becomes a SiRR reader to ensure capture of wanted RFID. When lower power and narrower beam width is chosen, the device becomes a SeRR reader, so that it can accurately read RFID at a short distance with more accurate aiming at the RFID tag. Signal frequency, antenna and other functions may be changed in switch from SiRR to SeRR reader and back if needed, to enable better performance. This device (SiRR reader, SeRR reader, or the two combined) can have a computer to control its functions. It can also store a list of RFID (e.g. the RFID embedded in name tags on people), compare the captured RFID with the list, and count the number of RFID captured (see below for its use). When this device is selected to perform as SiRR reader, it can reveal the number of RFID captured after each photo-shooting, so that photographer can know how accurate the RFID capture is. If photographer sees that the number of RFID captured is more than the number of people in the photo, he or she can switch this device into a SeRR reader, and use it to accurately read the RFID of the people in the photo. The SeRR reading can replace the SiRR reading, or be treated as the more accurate RFID metadata.

Generally, it is easier to identify people in photos taken in a small event (e.g. 50 people in a birthday party) of a short duration (preferably within a day) than in a very big event (e.g. >10,000 people). Photos of small events can be handled in multiple ways, and two examples, according to some embodiments, are shown below.

Example 1: In a small event of a short duration, it may not be necessary to use RFID technology to identify people in photos. Putting tags on people and matching RFID with people may still be some amount of work, and may need people to cooperate. Appearance recognition technology (ART) may be sufficient for sorting and delivering photos to right people in an event of not many people. As the term is used herein, ART uses not only traditional facial features (relatively unchanging over time, generally used in traditional facial recognition, which can include, for example, characteristics, geometry, and shape of the heads, face, eyes, nose, mouth, cheeks, chin or ears, and/or portions, elements, and/or aspects thereof, and/or distances or relative distances associated with or between such features or elements thereof), but also one or more non-traditional facial features or other appearance characteristics. In some embodiments, such non-traditional features or characteristics can include, for example, among other things, hair style, facial hair or style, makeup, eyeglasses, hair, clothing, pants, shirts, hats, shoes, jewelry, earrings, body height, body size, and/or tattoos.

For example, in events that last for a short time (preferably within a day), people often don't change at all, or only change very minimally (e.g. change clothes, jewelries, makeup, etc.). Therefore, in some embodiments, in this kind of events, ART can use so many more recognition features than traditional facial recognition, which makes ART much more accurate than traditional facial recognition. Another advantage ART may enjoy in small events is that it is rare for people to look very similar and wear almost everything the same, so ART may not need to handle difficult recognition task in small events. ART does not usually have a database (collection) of people's appearances for identifying people in the photos after photos are sorted by ART. In a small event, the total number of photos is typically not huge (e.g. <500). ART can be used to sort the photos, which is usually grouping all the photos that belong to each person. In some embodiments, after grouping, IDPHOTO Support can point out the person that appeared in all the photos in each group, and the identity of the person can be recognized manually (manageable for small events). In some embodiments, IDPHOTO Support also can provide photo sharing/delivering service, which can deliver photos to people in multiple ways (explained below in Section 3). In general, IDPHOTO Support enables utilization of ART for photo processing, such as sorting and organizing photos, and other functions, such as protecting privacy and delivering photos and identifying photos (e.g. with RFID, see below).

Example 2: If people in small events (e.g. a birthday party of <50 people) wear name tags with RFID tags embedded (every person has a unique RFID), using SeRR reader (coupled to camera) to capture RFID before or after photo-shooting can enable identifying people in the photos. Since SeRR reader capture RFID accurately, unwanted RFID is generally not captured, so it can be unnecessary to use ART or other assistance to separate unwanted RFID. After the event, photos can be loaded into computer and processed by IDPHOTO Support, which may not use ART. IDPHOTO Support can sort and group photos according to RFID metadata (e.g. all the photos with one RFID as one group). In order for RFID to identify people in photos without ART, RFID needs to be captured accurately for all the photos (no unwanted RFID capturing). However, if ART is used, a photographer does not have to use SeRR reader to capture RFID every time he or she takes a picture (so that work can be reduced), he or she can just capture everybody's RFID once (prefer in single photos: one person in each photo). When RFID is captured, it can be counted by SeRR reader. So when SeRR reader tells photographer that all RFID is captured (counted to the total number of RFID), he or she can stop using SeRR reader, and just use camera to take pictures. All the RFID can be loaded into SeRR reader before the event. When a RFID is captured, it can be compared to the list of RFID loaded in the beginning, so that the remaining ones not captured can be shown on a screen of SeRR reader. If people's names and their RFID are paired in SeRR reader, people's names can be shown, so that photographer can know whose RFID has not been captured. After photos are loaded from camera to computer, IDPHOTO Support can use ART as described in Example 1 to sort and group photos. Every group of photos has one person appeared in all the photos. The RFID captured by SeRR reader can enable IDPHOTO Support to identify the person who appeared in all the photos of a group of photos, and deliver the photos to the right people (e.g. through email or using photo-sharing/delivering platform, see below), since RFID can correlate with emails or photo-sharing/delivering accounts. See Section 3 for more.

In some embodiments, in a very big event (e.g. greater than thousands or tens of thousands people), ART without any assistance (e.g. GPAR, time and location, etc.) may well be insufficient for the job of accurately sorting photos according to appearances. The likelihood of people looking similar and wearing similar clothes increases with the number of people. In addition, without a database (collection) of people's appearances, ART cannot identify people. RFID technology combining with ART can sort photos and recognize people in photos. With the help of ART, it is not necessary to use advanced RFID technology to avoid (or minimize) unwanted RFID reading or separate unwanted RFID reading (e.g. detecting position of RFID tag or detecting signal direction-of-arrival, see above), because ART can be used to separate unwanted RFID reading and correlate RFID with appearance. A low cost simple SiRR reader (coupled with a camera) that has sufficient reading range (e.g. >10 m) can be designed to capture the wanted RFID (for people in the photos) during photo-shooting. And it is ok if it reads (records) some unwanted RFID from time to time from people nearby. Even though the simple SiRR reader cannot avoid reading some unwanted RFID, it can still be designed to minimize the unwanted reading. For example, the simple SiRR reader can have multiple settings of power and/or beam width. Photographers can choose settings based on distance of the targeted people, so that the right amount of RF power is used to avoid reading RFID in the back. Settings of beam width can be chosen to minimize capturing RFID of people on the side. In the end, the unavoidable unwanted RFID (captured by SiRR reader) can be separated out using ART. The combination of RFID technology and ART may work best for sorting and organizing photos (validating RFID) for people who took multiple photos, when SeRR reader is not used.

In some embodiments, after all the photos (RFID metadata captured by SiRR reader (SeRR reader not used) are loaded into a computer, IDPHOTO Support can put together all the photos that have a same RFID (a target RFID). In this group of photos, the captured RFID is analyzed to see whether there are other RFID that appear in high frequency. If there are multiple RFID associate with the target RFID in high frequency, these RFID and the target RFID are likely from a group of people who like to take photos together. If there is no group association of RFID, ART is then used to recognize which one person appeared in all or most of these photos, and this person should have the target RFID (RFID validation). The accidentally captured RFID (unwanted RFID) is very unlikely to appear in high frequency in these photos. If there is a group association of RFID, and the group of people often appeared in the photos together, this group of people may be recognized together by ART, and may not individually. After recognition (RFID association with appearance of a person or a group of RFID with a group of people), ART can be used to remove photos that do not have the person or the group of people (RFID unintentionally read), and the recognition features can be used to analyze other photos for the person or the group of people, in case the RFID was not captured in those photos. In general, in more photos a person (or group of people) appeared and in fewer photos the RFID of a person (or group of people) is accidentally captured, the more easily the RFID of the person (or group of people) can be validated and the person (or group of people) can be recognized by ART (building correlation between RFID and appearance). IDPHOTO Support can first validate the more easily validatable RFID. The more RFID can be validated (correlation built between RFID and appearance), the more unwanted RFID can be removed by ART. After more and more RFID is validated, the remaining RFID validation becomes easier, because less unwanted RFID is left. Finally, the number of validated RFID in each photo can be compared with the number of people in the photo to verify the validation.

In some embodiments, if SeRR reader is not used, and only SiRR reader is used in photo-shooting, ART needs to be used to validate most if not all RFID, and figure out correlation between appearance(s) and each RFID or a group of RFID (described in the above paragraph). Since SeRR readers can capture RFID very accurately, using SeRR readers can reduce the number of RFID needs validation, so it is beneficial to use both SeRR and SiRR readers. Using SiRR reader is convenient, and using SeRR reader (occasionally) makes validation of RFID more accurate and easier. Most if not all RFID captured by SeRR reader does not need validation, since it is very accurate (no unwanted RFID captured in most if not all cases). With a group of RFID captured by SeRR reader, and thus validated, the rest of RFID validation by ART becomes easier. If all (or at least most) of the RFID can be captured accurately (no unwanted RFID capture) either by SeRR reader, or SiRR reader in some occasions (e.g. GPAR, described below), it may not be necessary to use ART, since no RFID needs validation. But ART can still be used to verify whether RFID and appearance correlation is consistent.

In some embodiments, if all RFID are validated, or correlations between RFID and appearance are built for all RFID (e.g. using entrance Gate GPAR, see below), photos taken by SiRR cameras can be analyzed quickly by comparing the appearances of the people in the photos to the appearances of the captured RFID, in case the number of captured RFID is more than the number of people in the photos. The RFID of the people in the photos can be determined by the match of appearances.

In some embodiments, RFID technology can dramatically reduce the number of photos (of a big event) need to be analyzed by ART (e.g. for validation of a RFID when SeRR reader is not used), which is very significant because the total number of photos can be huge for a very big event. Each RFID may only appear in tens or hundreds of photos, so the person who carried that RFID can be recognized by analyzing the tens or hundreds of photos, instead of a huge number of photos (e.g. >100,000). Since it is a very big event, it is likely to have similar-looking people who wear similar clothes. Therefore, ART without any assistance (e.g. GPAR, time and location, etc.) may have limited accuracy for sorting photos of a very big event. A combination of ART with RFID technology is likely necessary in many situations.

In some embodiments, in addition, group association can be used by ART to make recognition even more accurate, after a group is recognized (e.g. through RFID association, see above). For example, a family likes to take photos together, so if a family member is identified in a photo, it is likely other members are in the photo, too. In IDPHOTO Support, group association and recognition features of ART can be given different weight for recognition based on the certainty in recognition. If a group is given a same RFID, group association is defined by the same RFID.

In some embodiments, when used for RFID validation, ART is not for uniquely identifying each RFID for each person; it is for validating RFID as wanted for the people in photos, and thus separating out the unintentionally captured (unwanted) RFID. ART may not always be able to uniquely identify each RFID. For example, if a group of people always appear together in photos, this group of people's RFID cannot be individually identified. But the RFID of this group can still be validated (correlation between a group of RFID and a group of people) and separated from unwanted RFID.

In some embodiments, the camera coupled with SiRR reader can also be designed to avoid taking photos if it does not detect a response from RFID tag. People without RFID tag may indicate they do not want their photos taken.

In some embodiments, in addition to RFID reader (coupled to camera), RFID tags (prefer passive and semi-passive for cost saving), and ART, IDPHOTO can also include software, support and online photo-sharing/delivering service (platform, website). When the camera coupled with SiRR reader takes photos of a group of people, the RFID tags attached to the people in front of the camera are read at the same time, and the captured RFID are associated with the photos as metadata through communication between RFID reader and camera. The captured RFID may include wanted ones (belong to the people in the photos) and unwanted ones (belong to people outside the photos or no need to be in). After the photos (along with their RFID metadata) are downloaded to a computer from a camera, IDPHOTO Support can use ART (described above) to validate the RFID associated with each photo (to determine wanted RFID, and separate/discard unwanted). It can generate a profile of RFID with appearance to allow verification for accuracy (correlation between RFID and appearance). It can also organize (group) photos according to RFID. After RFID is validated, IDPHOTO Support can delete unwanted RFID metadata from photos to protect privacy of the people who accidentally appeared in photos. Since correlations between RFID and appearances are established by IDPHOTO Support (using ART), IDPHOTO Support knows the wanted people in photos, who have the wanted RFID. With this knowledge, the privacy of people who accidentally appeared in photos (unwanted people) can be further protected by IDPHOTO Support, because this support can modify the facial appearance of the unwanted people in photos.

In some embodiments, after RFID is validated and photos are sorted and organized according to the validated RFID, the photos can be sent by emails to correct people (in the photos) automatically using IDPHOTO Support, because RFID can be associated with emails. In addition, the sorted and organized photos can also be automatically uploaded (through IDPHOTO Support) to the accounts of online photo-sharing/delivering platform, as long as RFID can point to the accounts.

In some embodiments, IDPHOTO can also provide an online photo-sharing/delivering service (platform, website). This online photo-sharing/delivering service have been described in MICO (US provisional patent application #61902660), and IDPHOTO can be part of MICO. The services include delivering photos to MICO accounts to allow MICO customers to view, select, purchase, and download photos.

In some embodiments, RFID technology and ART can be used together in a big amusement park setting. For a big amusement park (e.g. Disney Parks, Six Flag, Lego Land, Universal Studio, Great America, etc.), the number of its customers can be huge every day, which can make sorting and organizing photos a difficult task because the number of photos can be huge, especially when the parks expand their photo business and take many photos for most (if not all) of their customers. The traditional facial recognition technology may well be insufficient for the job (reasons stated above). At the present days, an amusement park takes photos of its customers, and ask them to come to photo both to find their photos and buy them. It is usually expensive for just a few prints. Better parks may include the digital form in the sale. Many customers choose not to have their photos taken by the park, because of the high price and inconvenience. Even customers choose to take the photos, they often refuse to buy them, which results in a waste of photo prints that adds to the cost for the park.

In some embodiments, using a combination of ART and RFID technology (SiRR and SeRR reader) can allow an amusement park to take many more photos for the customers, sort/organize the photos, and deliver them to the right customers for them to select and purchase. At the entrance of an amusement park, the park can ask the customers to leave an email and wear a wrist band (embedded with RFID tag). Email and RFID are then associated. In return from taking the wrist bands, the customers may get first 20 photos free, and be able to buy many photos at lower price from IDPHOTO photo-sharing/delivering service (platform, website), after their visit of the park. The customers can get from their email a web link to a temporary account of IDPHOTO photo-sharing/delivering service (and possibly a password). They can access the temporary account to select the photos taken by the park and buy them. If this is their first time to use IDPHOTO, they can be asked to establish a (permanent) account with IDPHOTO. If not the first time, their photo can be directed from temporary account to their (permanent) account by telling IDPHOTO where (what) their account is. Customers can also tell the park at the entrance what their IDPHOTO account is, or what their IDPHOTO ID is, so that their photos can be delivered directly to their account for selecting and purchasing. Alternatively, at the entrance, customers can be given wrist bands (RFID tags) and a card that has a unique website and/or a (2D) barcode, which can be scanned to lead to a unique website. This card can be issued using TAD (see Section 3). The RFID (wrist bands) is associated with the unique website. This website can lead to IDPHOTO photo-sharing/delivering temporary account, where customers can view, select, purchase, transfer and download photos taken by the parks.

In some embodiments, it the park entrance after getting the email or IDPHOTO ID from the customers, or giving them a card that has a unique website and/or a (2D) barcode (e.g. using TAD, Section 3), and giving RFID wrist bands to them, the park can take a group photo of family or any group using cameras coupled with RFID reader. The entrance group photo can be taken in front of a screen that can block RF from passing through, so that taking the group photos can record all the wanted RFID and avoid read unwanted RFID when SiRR reader is used. A group can be all given a same RFID, if photos of the group can be delivered to one place. The group association technology of ART (see above) is very useful for an amusement park to sort and organize photos, because people often go to amusement park in family or group, and they often take photos together. The entrance group photos can make sorting and organizing photos easier for IDPHOTO. RFID can be captured very accurately for these photos (with no or very minimum capture of unwanted RFID), so RFID can be validated and appearances can be associated with RFID for groups using entrance group photos, even though not individually. Other group photos can also be taken at various places in amusement parks in a similar way as the entrance photos or in ways that can avoid or minimize reading of unwanted RFID. In addition to RF blocking screen, other methods can also be used to avoid (or minimize) unwanted RFID reading. These group or individual photos, including entrance group photos, are called group or individual photos with accurate reading of RFID (for short, GPAR). Places (in amusement parks) can be identified where people can take photos away from other people. GPAR can be obtained in these places to avoid (or minimize) unwanted RFID reading. GPAR is usually taken by camera coupled to SiRR reader, because using SeRR reader to capture a group of people (RFID) is really not convenient, unless members of a group all have a same RFID. Antennas of SiRR readers can be positioned to avoid (or minimize) unwanted RFID reading. Well positioned antennas possibly can avoid (or minimize) unwanted RFID reading even in crowded places. All these GPAR can significantly enhance the validation of RFID and building of correlations between RFID and appearances.

In some embodiments, there is a special GPAR, called Gate GPAR. Gate GPAR is one kind of GPAR taken at a gate. Antennas can be mounted around (or nearby) the gate to accurately capture RFID when people go through the gate. Photos (Gate GPAR) can also be taken when people go through the gate. The capture of RFID when people go through can trigger the photo shooting. Gate GPAR may prefer one person walking through the gate at a time, if accurate capture of RFID requires that. The position, orientation and angle of antennas can be adjusted for accurate capture of RFID when people walk through the gate, so can the reading range and signal beam width. Gate GPAR can also ask people to tap their RFID tag (e.g. wrist band) on the reader (e.g. using NFC technology) to capture their RFID, when they pass through the gate. Gate GPAR can make excellent correlations between RFID and appearance. If amusement parks set up Gate GPAR (e.g. at the gates of rides) at multiple locations, park entrance group photos, group association, and time/location metadata are less important for the overall identification task using IDPHOTO. On the other hand, Gate GPAR can be set up at the park entrance (as another form of park entrance photo), because it is automatic. Gate GPAR is especially useful for the rides of amusement parks, which is explained below.

Rides of amusement parks may be their major attractions. Surprisingly, many parks do not take (many) photos for people in their rides, and these photos often cannot be shot by customers. In some embodiments, if the technical problems are solved (as IDPHOTO intends to do), the photo business (including those for the rides) can become very attractive to customers and good revenues for the parks. Amusement parks can use Gate GPAR to facilitate delivering the photos taken during rides to the right people. Before getting on a ride, customers have to go through a gate, which is used to separate people who will take the ride from people who need to wait. The gate before a ride can be used for Gate GPAR, so that all the people who are about to go on the ride can have their RFID and appearance correlations built right before the ride. If RFID and appearance correlations have been built (e.g. using park entrance Gate GPAR), Gate GPAR may not need to take photos (even though this is not preferred), it can be used to just capture RFID of the people who pass through the gate, so that IDPHOTO can know who will be on the ride. Automatic cameras can be set up along the ride to capture the exciting moments of the ride. These cameras do not have to couple to RFID readers, because Gate GPAR has built the correlations between RFID and appearance at the gate. All the photos along the ride can be sorted by ART according to appearances (RFID is not necessary), which can be linked to RFID according to the correlations between RFID and appearance. Then all the photos can be delivered to the right people according to their RFID. Since only a small group of people get on a ride at a time, ART is very capable of sorting all the photos captured in a ride according to appearances (see small event Example 1). And since a fresh and accurate correlations between RFID and appearance are built for people on a ride every time just before people get on a ride, the sorted photos according to appearances can be linked to RFID accurately, and thus delivered to the right people according to RFID. This is a similar situation to a small event, as described above.

In some embodiments, Gate GPAR can use mature and non-sophisticated technologies, which can make implementation straightforward and cost effective. The setup of Gate GPAR does not have to be changed (much) from one situation to another (e.g. from one ride to another), so the manufacturing and setup can be standardized, and thus become cost effective. The operation of Gate GPAR is automatic, which again can be cost effective. Gate GPAR enables all cameras along any ride to be without the need to couple to RFID readers, which again is cost saving. In addition, Gate GPAR provides very accurate correlations between RFID and appearance, especially for people who are about to get on a ride.

In some embodiments, there are other ways to handle photo taking and delivering for rides, but using Gate GPAR, as described in the above paragraph, has multiple advantages. The following two paragraphs describe photo taking and delivering for rides without using Gate GPAR.

Many of these rides carry a group of people to places away from crowds. In some embodiments, this can be a good situation for GPAR, because only the group of people who should be in photos are close to cameras and no other people (unwanted RFID) nearby. The rides may carry more than one families, which can be easily distinguished using RFID and ART. In this situation, correlations between appearances and seat positions in rides are also very useful to identifying people. Anything useful for identifying people can be used by ART, and certain things are only useful in some situations. Amusement parks can set up multiple (automatic preferred) cameras (coupled with RFID reader) along many rides to capture the fun and unique moments during the rides. These cameras (automatic preferred) should be coupled to SiRR readers. SeRR readers do not work well in the situation of fast-moving rides in amusement parks. Disney World parks appear to be using SiRR cameras to capture moments in a few of their rides and deliver these photos automatically. They ask customers to wear a wrist band called MagicBand, which is a new and key addition to RFID technology Disney is using and heavily investing. MagicBand seems to have active RFID tag embedded, so that it has long reading range. MagicBand seems to be required for automatic delivery of on-ride photos. Otherwise, customers need to stop by photo shop to associate their photos to themselves. Just using SiRR cameras (e.g. without assistance of ART, Gate GPAR) for identifying people and delivering photos may have limitations. If people in a ride belong to multiple families, photos may not be delivered accurately just based on RFID, since all the RFID (multiple families) in a ride can be captured. If a ride moves very fast, SiRR cameras may not be able to capture all RFID quickly enough.

In some embodiments, if capturing RFID is difficult when rides are very fast-moving (e.g. data transfer is not quick enough for RFID), the RFID can be captured in a slow moving portion of rides. In the beginning of rides, the speed is usually slow, so these beginning sections of rides are good places for capturing RFID accurately. Antennas of SiRR readers can be set up on optimal spots to capture RFID when photos are taken. Multiple antennas can be set up, and positions of RFID tags can be determined (e.g. through time-of-flight), so that correlations between RFID and seat positions can be established. These photos taken in the beginning sections of rides can avoid capturing unwanted RFID, because the rides are usually away from crowds. Therefore, these photos can have accurately captured RFID (using SiRR readers), and thus correlations can be established between RFID and appearance. In addition, correlations can be established between RFID and seat positions. Since the beginning sections of rides are usually slow, SeRR readers can also be used. Antennas can be placed on both sides of rides, and people in rides can be asked to tap their RFID tags (e.g. wrist bands) on the antennas, or simply raise their hands (for a better position to read the wrist bands). Because these readings of RFID are captured in sequence, these RFID can be correlated with seat positions. Photos may not have to be taken when RFID is read by the SeRR readers, because IDPHOTO can have correlations between RFID and appearances established at the park entrance. With these two correlations (RFID to appearance and seat position), the photos taken in the later sections of rides may not need to capture RFID again, because people in the later photos can be identified using these correlations and ART without RFID. Even without the correlations between RFID and seat positions, the correlations between appearances and RFID and ART should still be enough for identifying people in photos.

In some embodiments, cameras coupled to SeRR readers can be used in some places of amusement parks (e.g. crowded places). Photos taken by these cameras should have accurately captured RFID metadata, like GPAR. With the help of GPAR and photos taken with cameras coupled to SeRR readers (can serve as master photos with great analyzing weight), analyzing photos and validation of RFID becomes much easier and more accurate for IDPHOTO (ART is a part of IDPHOTO), even though validation of RFID without these helps can still be effective using IDPHOTO as described above. In addition, group association is another tool that enables accurate sorting and organizing photos in the setting of amusement parks. Time and location metadata of photos can be useful (e.g. to group association, because a group (or part of a group) is usually around the same place at the same time). Time and location can be analyzed along with group association, RFID and appearance recognition to make correlations. One way to capture location metadata is to use SiRR/SeRR reader ID. These reader ID can be captured with photos. SiRR/SeRR readers usually stay in specific locations. In short, with the help of GPAR, photos taken with cameras coupled to SeRR readers (SeRR photos), group association, time and location, IDPHOTO can very accurately sort and organize photos for amusement parks using ART and RFID.

In some embodiments, after the entrance, the park can distribute many photographers in every important location. These photographers can take many photos of the customers who visit their locations. Since the customers wear RFID (wrist bands), these photos can have associated RFID metadata. Then IDPHOTO Support can automatically sort and organize all the photos using RFID metadata and ART, with the assistance from GPAR, SeRR photos, group association, time and place metadata, even though the assistance is not required. IDPHOTO Support can also automatically distribute the sorted photos to the right accounts. If customers do not have an account, the photos can be delivered to a temporary account, which customers can access through their email, or through the card they obtained at the entrance, which can have a website and/or 2D barcode.

The two paragraphs above describe a situation that Gate GPAR is not used. In some embodiments, when Gate GPAR is used, especially when it is extensively used (e.g. for all the rides), accurately sorting and delivering photos becomes easier for IDPHOTO Support.

In some embodiments, even though passive and semi-passive RFID tags are preferred due to the low cost, active RFID tags can also be used, because they have long reading range, and RFID reader can use lower power with active tags. High power from RFID readers can interfere with each other and other devices. Amusement parks may ask their customers to return active RFID tags when they exit the parks, because of the higher cost of active RFID tags.

In some embodiments, in amusement parks, a combination of ART and SiRR/SeRR devices coupled to cameras (with the assistance of GPAR, SeRR photos, time and location metadata, etc.) give excellent result of accurately identify people in photos, as described above. However, ART can identify people in photos to an acceptable accuracy without RFID technology and with the help of entrance photos, group association, and time/place metadata. ART can be used to sort and organize photos according to people's appearances, and it needs a database of people's appearance and identity correlation in order to identify people in photos. For photo-sharing/delivering service, ART at least needs to correlate people's appearance with where to send photos. At the entrance, visitors can be asked to take an entrance group photo, and provide their emails (or IDPHOTO account ID), or be given a card with a unique website (for a temporary account of photo sharing/delivering), so that the entrance photo and emails (or account ID, temporary account) are associated (for delivering photos, see above). The entrance photos are used as the base for appearance recognition, and all other photos in the park are analyzed using the appearances in entrance photos. In amusement parks, group association is very strong, because families like to stay together. Within a day, people don't change much, which may include what they wear, so ART can use many features to identify people. Time and location metadata of photos can also be used, as described above. Therefore, ART has the potential to identify many people in photos to an acceptable accuracy without RFID technology in a situation like amusement parks, with the assistance of group association, time, location, and entrance photos as the database of appearance/identity.

In some embodiments, if SiRR cameras (cameras coupled with SiRR readers) are only used to take GPAR (e.g. entrance photo in front of RF screen, in a remote area of a ride away from crowds) to avoid (or minimize) capturing unwanted RFID, and SeRR cameras (cameras coupled with SeRR readers) can be used in crowded places, ART may not be needed for RFID validation, but ART can still be used for RFID and appearance correlations and enhancing accuracy.

In some embodiments, the photography business of cruise ships can also benefit from using ART and RFID technology to accurately identify people in photos in order to sort photos and accurately distribute the right photos to the right customers. At the present days, the photography business on cruise ships is similar to that of amusement parks. The ships take many photos for their customers, ask their customers to go through all the prints to find theirs, and buy them (at a pretty high price). As described above, cruise ships can use a combination of ART and SiRR/SeRR cameras with or without the assistance of GPAR, SeRR photos, time and location metadata, and group association, in order to achieve the sufficient accuracy of identifying people in photos. In some situations, ART or SiRR/SeRR cameras may be used alone and achieve acceptable accuracy, as described above.

In some embodiments, the photography business of ski resorts can also benefit from using ART and RFID technology to accurately identify people in photos in order to sort photos and accurately distribute the right photos to the right customers. EpicMix Photo of Vail Resort is using RFID for the photo business, but they mainly use SeRR reader to capture RFID for people taking photos. Improvement can be made. A challenge is how to deliver photos of fast ski run to the right people (these photos are very attractive to customers). Cameras may have to be at a distance, so the reading range of RFID may have to be very long. Fast moving also makes capture of RFID difficult. Gate GPAR (see above) and ART can be used to accurately identify people in fast ski run, so that many photos can be taken for them and delivered to them. At the top of a ski slope, a “gate” with RFID reader and antennas can be set up (for Gate GPAR), and people can go through the “gate” to have their RFID captured and an automatic photo taken (e.g. triggered by reading of RFID), so that correlations between RFID and appearance can be built. These correlations can be really important, if there are many people go through the “gate” in a short period of time, and the sequence of people down the slope may not be the same of the sequence of the reading of RFID. After the “gate” and along the ski slope, (automatic) cameras (not necessary to couple with RFID readers) can be set up to take many photos of the people out of the “gate”. People in these photos can be identified by appearances, and sorted according to appearances. The correlations between appearances and RFID (built at the “gate”) can be used to link RFID to people, and enable delivering these photos to the right people.

In some embodiments, overall, in order to identify people in photos (at least as a group, if not individually) and/or deliver right photos to right people, SiRR/SeRR cameras, ART (or IDPHOTO Support), and combinations can be used. SiRR cameras try to capture all the wanted RFID at the risk of capturing some unwanted RFID. SiRR cameras can use sophisticated RFID technology (e.g. UWB RFID for accurate positioning of RFID tag) to separate unwanted RFID, and they can also use regular RFID technology (low cost) and unwanted RFID can be separated by ART. SeRR cameras are less convenient, but can be more accurate in capturing RFID than SiRR cameras. SiRR and SeRR cameras can be used together or separately. It is very effective (accurately identify people in photos) and convenient to use the combination of SiRR/SeRR cameras and ART (or IDPHOTO Support), especially in a complicated big event, such as in an amusement park. Just using SiRR/SeRR cameras or ART (or IDPHOTO Support) can achieve acceptable effectiveness in certain ways, especially in less complicated events (e.g. a small birthday party). Some assistance can increase effectiveness, such as GPAR, Gate GPAR, SeRR photos, time and location metadata, and group association, when used along with SiRR/SeRR cameras and/or ART (or IDPHOTO Support), especially in a complicated big event, such as in an amusement park. Gate GPAR can especially increase effectiveness. IDPHOTO Support enables using ART to validate RFID (separate unwanted RFID from wanted ones), build correlations between RFID and appearances, and sort and organize photos (e.g. group photos together that belong to a person or a group of people). It can delete unwanted RFID metadata to protect the privacy of people who accidentally appeared in photos (unwanted people). It can modify the appearances of unwanted people in photos to further protect their privacy, before the photos are distributed. It can also distribute photos to the right people through emails or photo-sharing/delivering platform.

In some embodiments, since MICO and ARTAS can issue ID to the customers (for their accounts), they can issue ID card with RFID tag (in addition to a barcode, as described in previous provisional applications, see attachment). In some embodiments, this ID card prefers to use active RFID tag, so that the RFID signal can be turned on and off, to guard privacy. This ID card can also be a part of a mobile phone, which means that a personal mobile phone has a (active) RFID tag that has the person's MICO or ARTAS ID. With this kind of ID card (or mobile phone), a person can turn on the RFID tag, and allow his or her ID read during photo-taking. His or her MICO (or ARTAS) ID can allow the photos distributed to his or her MICO (or ARTAS) account. If not for long range communication, mobile devices can use NFC technology.

In some embodiments, ART is used as the recognition technology. Generally, ART is more effective and more accurate than traditional facial recognition technology for appropriate situations, because ART uses many more recognition features. However, in some less complicated situations (e.g. Gate GPAR), traditional facial recognition may be sufficient (e.g. for separating unwanted RFID, sorting/grouping photos, etc.) when combined with RFID devices (SiRR reader, SeRR reader, or the two combined), with or without assistance of GPAR and group association techniques, and/or time and location metadata.

The description of IDPHOTO above may generally use photos, but other embodiments can include video and other digital media, or other content.

### Instant Awesome (IA)

In some embodiments, Instant Awesome (IA) is another part of IDPHOTO Support. It enables people to view their photos on their mobile devices (e.g. phones or tablets), not long after their photos taken by IDPHOTO enabled services (e.g. photo services provided by amusement parks using IDPHOTO). IDPHOTO can provide a mobile app (IDPHOTO mobile app), which can enable people to view their photos taken by IDPHOTO enabled services.

In some embodiments, the following is an example how IA can be used in amusement parks. At the entrance, a customer can be given a RFID tag (e.g. a wrist band embedded with RFID tags) and a card with a 2D barcode (e.g. using TAD, see Section 3). The RFID and the 2D barcode are correlated by IDPHOTO. The customer can scan the 2D barcode using IDPHOTO mobile app, which can lead to a temporary account of IDPHOTO. In this temporary account, customer's photos taken in the amusement park can be posted. As described in Section 1, IDPHOTO has many tools to accurately identify people in photos (build correlations between photos (appearances) and RFID), using combinations of SiRR/SeRR cameras and ART, with the assistance of GPAR, group association, time/location metadata, etc. After photos are identified (photos are correlated with RFID), IDPHOTO can distribute the photos to the correct temporary accounts, because RFID correlates to 2D barcode, which leads to the correct temporary account. The correlation and distribution of photos by IDPHOTO can be done quickly, so that customers at amusement parks can possibly view their (crazy) photos in rides right after getting off the rides. This can create a lot of fun for customers. If customers are willing, they can share their crazy photos in IDPHOTO mobile app, or using other tools (e.g. other photo-sharing social media). The amusement park can have a crazy photo contest.

In some embodiments, if customers have permanent accounts with IDPHOTO, they do not need to get a card with a 2D barcode at the entrance of a park. They can open IDPHOTO mobile app and tap their mobile devices with an IDPHOTO device (e.g. TAD), so that their IDPHOTO account info is captured, and correlate with the RFID they received (e.g. wrist bands) at the entrance (e.g. using TAD).

In some embodiments, with IDPHOTO mobile app, it becomes easier to use SeRR cameras in amusement parks, because customers can be encouraged to have their RFID captured by SeRR readers in order to view their photos quickly. Customers can approach SeRR readers to have their RFID tags read, which can save photographers a lot of work. SeRR photos can be loaded to customers' IDPHOTO accounts quickly, because the RFID is accurately captured, no RFID validation is needed.

In some embodiments, with IDPHOTO mobile app, customers can view all the photos taken in an amusement park before they leave the park, and decide which ones they want to buy. They may get a discount if they buy before they leave.

### Expansion For the Photo-Sharing/Delivering and Photo Market Services of MICO

In some embodiments, MICO can collect many memory related materials for its customers (with their consent), deliver the materials to their accounts, and enable the materials organized and easily searchable. All these services are provided without requiring customers to do anything, or with minimum customer involvement (e.g. in the case of POB). Photos are very important memory related materials, so MICO likes to collect and deliver to its customers their photos as many and necessary as possible, and the right ones, because people generally only care about the photos that have themselves and their loved one. The existing photo-sharing/delivering services generally deliver all the photos (e.g. taken in a party) to people, so people have to go through all the photos to find the ones they like, and save or download them if permitted (many services do not allow download). MICO can sort the photos and deliver (or highlight) the right ones. After delivering, customers can buy (if required) and download the photos (e.g. high resolution ones), or choose to keep them in their MICO account.

In some embodiments, after people upload photos (e.g. taken in a birthday party) to MICO, which can be easily done (see below and Attachment), MICO can use ART (and RFID if used) to sort the photos and deliver the selected photos to customers (see Section 1: IDPHOTO). If people like to receive all the photos (e.g. of a small event), the delivered photos are sorted and organized, so that people can easily find their photos and save these photos if they don't like to save all. If people have a MICO account, MICO probably has their photos (in their account) that can be used to recognize them in uploaded photos after MICO sort them using ART (and RFID if used), so that MICO can deliver the photos in which they appeared, or highlight the photos for easy finding. If people don't have MICO account, they can go to a temporary MICO account (e.g. through a web link in email) for the sorted photos.

In some embodiments, since MICO can offer unique and better services (described in this application and attachment), it has the potential to be widely adopted as preferred photo-sharing/delivering service provider. Services provided by MICO can include those using PBO and IDPHOTO. IDPHOTO can allow amusement parks to provide much better photo service to their customers (see the section above), and thus expand the photo business. So when amusement parks adopt the photo service provided through IDPHOTO, a great many of customers likely will set up accounts with IDPHOTO photo-sharing/delivering, which can be a part of MICO.

In some embodiments, MICO can also serve as an online marketplace for photographers to sell their photos. At the present time, there is not a well-known online marketplace to both photographers and customers where photographers can deliver photos to right customers for them to select and buy the photos. If this marketplace exists, photographers can go to National Parks (Yosemite, Yellow Stone, etc.), State Parks, or other tourist popular areas and provide their photography services (e.g. shooting beautiful professional photos for people and sell the photos). Obviously, photographers can also sell other kinds of photos. For this online photo marketplace to work well, it should be convenient and well-known to both photographers and customers, and it can deliver photos to the right customers. As stated above, MICO has the potential to be widely adopted as preferred photo-sharing/delivering service provider, and it can deliver photos to customers accurately, so MICO can serve as the online marketplace. In addition, MICO can allow photographers to upload and deliver photos easily, and customers to select, buy, save, and search their photos easily. MICO also can protect customers' privacy. Photographers do not need to know or only need to know very minimally about customers for delivering photos (see below).

In some embodiments, for this online photo market to more optimally, MICO can design and provide a device that can print out a card (e.g. with a 2D barcode and a website) or write information into the RFID tag embedded in a card, to give to customers after photo is taken. This device is called temporary account device (TAD), because the card can have a website that leads to a photo-sharing/delivering temporary account (of MICO), where customers can select, buy and download photos as they want, and transfer photos to a permanent account if they have one. This card can also have a (2D) barcode and/or a RFID tag, which can be scanned or read, and lead to a photo-sharing/delivering temporary account (of MICO). Photographers can obtain a number of websites (photo-sharing/delivering temporary accounts) from MICO and store them in TAD. After a photo is taken, TAD assigns a website (a photo-sharing/delivering temporary account) with the photo as metadata and print the website out on a card, which is given to customer(s). Photographers can easily upload photos into to photo-sharing/delivering platform of MICO, and the website metadata can direct the photos to the right temporary accounts. MICO can alternatively provide a mobile phone app (e.g. IDHPOTO mobile app) that can take the website (a photo-sharing/delivering temporary account) through tapping TAD (using NFC technology).

In some embodiments, TAD not only can issue temporary accounts (e.g. printing a card with 2D barcode), as described above, it can also scan 2D barcode or read RFID to obtain temporary account from a card or mobile phone. If customers want to take more than one photos, TAD can scan the barcode on the card customers obtained when they took their first photo, so that all their photos can have the same temporary account metadata and go to the same temporary account. Alternatively, TAD can tap customers' mobile phones to communicate with the mobile app to obtain (read) the temporary account info as metadata for photos. These photos can be taken by more than one photographer, and loaded into IDPHOTO (or MICO) accounts (temporary or permanent) by different photographers. After photos are delivered to the temporary account, the mobile phone app also can access the website (the temporary account) to select, buy and download photos as they want, and transfer photos to a permanent account if they have one. This app can also sync with personal computer, so that customers can use big screen to select, buy and download photos as they want, and transfer photos to a permanent account if they have one.

In some embodiments, TAD can be a separate device from a camera, or attached to a camera. Communication between TAD and a camera can be wired or wireless (e.g. using Bluetooth technology). TAD can be used together with SiRR/SeRR cameras. TAD can also be combined with a SiRR/SeRR reader. TAD can have the ability to count barcode scanned or RFID read, and compare to a list stored in TAD, similar to what described for SeRR reader in Section 1, Example 2 for small events.

In some embodiments, TAD can be used at the entrance of an amusement park to provide temporary accounts (e.g. in the form of a card) to customers, and the temporary accounts are associated with the RFID (e.g. in wrist band) customers obtained (see above sections).

In some embodiments, TAD can be very helpful for event photographers to handle small events. Event photographers can use TAD to issue name tags or cards. The name tags or cards can have a barcode (1D or 2D) or RFID tag, which can lead to a temporary IDPHOTO (or MICO) account after scanning or reading. A family can all have the same barcode or RFID, because photos of a family can all go to one account. After issuing the name tags or cards, event photographers want to capture all the barcodes or RFID (on the card or name tag) before or after photo-taking at least one time, and this one time should be sufficient for building correlations between appearance and temporary account (e.g. barcode or RFID on the name tag). If a barcode (or RFID) is issued to one person, photographer can take his or her photo and scan (or read) his or her barcode (or RFID). If a barcode (or RFID) is issued to a family, photographer can take a group photo of the family and scan (or read) their barcode (or RFID). After the events, photographers can simply load all the photos into IDPHOTO (or MICO) photo sharing/delivering platform, and IDPHOTO (or MICO) can do the rest. IDPHOTO (or MICO) can use ART to sort photos according to appearances, and use correlations between appearance and temporary account to deliver the right photos to the right (temporary) accounts (see more in Section 1, Example 2 for small events). If people have permanent IDPHOTO (or MICO) accounts, photographers can take their photos, and tap their phones or scan their IDPHOTO (or MICO) ID using TAD. With the tapping or scanning, the photo(s) is associated with IDPHOTO (or MICO) account ID metadata.

In some embodiments, MICO can give its customers a card that has a barcode for the account number and/or a RFID tag carrying the account number. MICO customers can also choose to store their MICO account # in their mobile phones, which can be communicated through NFC (near field communication) technology. TAD can be designed to read RFID (e.g. using NFC) and/or scan barcodes. When MICO gain considerable popularity, photographers can take photos and capture customers MICO account ID through reading RFID or scanning barcodes on their MICO ID cards using TAD, or tapping their mobile phones (NFC communication between phones and TAD). MICO account ID # can be saved as a metadata with the photos through TAD. This metadata of MICO account ID # can be used to direct photos to the right accounts, when photos are uploaded into MICO.

In some embodiments, TAD can enable photographers to provide very convenient photography business to customers through MICO. For example, a photographer can pick a place with beautiful scenic view at a National Park, and take photos for tourists. After photo shooting, the photographer can use TAD to print a card to give to customers. Customers can use this card to gain access to a temporary MICO account for photo services (see above). Customers can also use mobile phone app to communicate with TAD to obtain a temporary MICO account. When MICO gain considerable popularity, the photographer can use TAD to just tap tourist's MICO ID card or mobile phone, or scan the ID card, after photo-shooting. With the tapping or scanning, the photo(s) is associated with MICO account ID metadata, and the photographer can just load the photos into MICO, and MICO knows where to deliver the photos.

In this section, in accordance with some embodiments, the expansion of photo-sharing/delivering and photo market services are described in the context of MICO. These services can also be provided under IDPHOTO, which may provide narrower range of service compared to MICO.

### A Good Photo Business in an Amusement Park

As described in the previous sections, especially Section 1, in some embodiments, there are multiple ways to use RFID technology and ART to identify people in photos and/or deliver right photos to right people for a situation like amusement parks. In this section, a good example is described to identify people in photos and/or deliver right photos to right people for an amusement park. This good example shows a good photo business of an amusement park that demonstrates convenience to customers and easy execution from the parks, provides very accurate identification of people in photos (for photo delivery) and uses mature and non-sophisticated technologies, which can lead to low cost for implementation.

In some embodiments, at the entrance of an amusement park, each customer is given a wrist band (embedded with RFID tags) and a card that has a 2D barcode, which can be scanned and lead to a temporary account of IDPHOTO (or MICO). A family can have a same card and wrist band, because all the photos of a family usually go to one account, unless it is requested to be different. The card and wrist band are linked together, so that RFID and temporary account are linked. The card can be issued by TAD (see above) and have a 2D barcode for a website and/or RFID tag that contains website information (for different ways to access temporary account). Customers can also use IDPHOTO mobile app to accept a temporary account. Issuing temporary accounts is convenient to first-time customers, because they do not need to set up an account before use. Setting up an account takes time, which is especially not good for a crowded park entrance. Using temporary account can also protect customers' privacy, if they do not want their permanent account known. If customers have their permanent accounts, they can show their account ID (e.g. IDPHOTO ID) to allow TAD to scan, or open IDPHOTO mobile app on their phone and tap their phone on TAD (for TAD to receive the account info), when they receive wrist bands, so that their RFID (in wrist bands) can be linked to their permanent accounts.

In some embodiments, at the entrance, Gate GPAR can be taken, after customers receive their RFID wrist band. Gate GPAR is automatic and quick, so customer entrance does not need to be slow down. The entrance Gate GPAR can provide the first correlations between RFID and appearance for most if not all the customers.

In some embodiments, to run this new photo business, the only involuntary change to customers is receiving a RFID wrist band and sometimes a card or tapping their phone on TAD, so the change to customers is very minimum. Receiving a card or tapping a phone is better than asking customers to leave their emails, because it is more convenient and protects customers' privacy. Amusement parks do not need to know who their customers are at all. Customers may choose to receive a card (and thus use a temporary account) even if they have a permanent account. Transferring photos from a temporary account to a permanent one can be easy. If customers really want to be private and do not want their photos taken by the parks, they can decline RFID wrist band. The parks can avoid taking Gate GPAR for them, because they do not have RFID to trigger Gate GPAR. Therefore, there is no correlation of RFID and appearance for them. If they are accidentally (or inevitably) taken into photos, their faces can be blurred or modified.

Rides may be major attractions for amusement parks, so good photos on rides may be good business for the parks and are very attractive to customers, because these photos are unique and cannot be taken by customers in many situations. In some embodiments, amusement parks can use Gate GPAR for rides as a key component for accurately identifying people in photos and for accurate delivery of photos. Many cameras can be set up along the rides. These cameras can be automatic and they do not need to couple to RFID readers (see Section 1, Gate GPAR for rides). Except photo processing, there is no change for how rides will be operated, after Gate GPAR is set up. Parks can also hire many photographers to take photos for customers in many places in the parks, using SiRR/SeRR cameras. The execution of this new photo business should be straightforward. Gate GPAR and SiRR/SeRR cameras all use mature and non-sophisticated RFID technology, so their implementation should be cost effective. In addition, in some embodiments, Gate GPAR setup can be standardized, because its setup does not need to change from a ride to another.

In some embodiments, customers can see their photos very quickly after photos are taken using IDPHOTO mobile app (see Instant Awesome, Section 2), which can create a lot of fun for customers, and deliver good photo business for the parks.

In some embodiments, with entrance Gate GPAR, other Gate GPAR, and SiRR/SeRR cameras throughout an amusement park, the safety of the park can be enhanced. If a child is lost in the park, the child can be quickly identified according RFID, and his or her parents can be quickly located according to where they took their last Gate GPAR or SiRR/SeRR photo.

### Expansion of MICO Service

In some embodiments, convenience to MICO customers is an important feature of MICO services. MICO provides unique services and does not require its customers to do much (or nothing at all) for the services. For example, many memory related materials are collected and delivered to MICO customer account automatically (with consent), organized, and easily searchable. MICO customers do not have to do any search, select, transfer, or copy for materials to appear in their accounts. In the case of POB, customers just need to scan the desired barcodes for the materials to be collected.

In some embodiments, MICO can encompass the articles, blogs, and other materials people read, watched, or listened to online. These materials may be linked to the websites people visited. People often read, listen or watch interesting materials online, and not many have the habit of saving the materials. From time to time, people remember the materials, think they are useful, and would read, listen or watch again if the materials could be found. But the materials often could not be found again, because people's memory may not be good enough, and searching tool is often limited to only keywords (e.g. using Google search).

In some embodiments, in order to solve or alleviate the problem, the materials people read or watched online should be saved, and there should be a better search tool (more than just keywords). However, it is not practical to ask many people to save all (or most) of the materials they read or watched, since it is not convenient, and a big portion of the materials may not be useful. A small portion of the materials may become useful unexpectedly in the future. This situation makes selecting and saving the materials difficult. Then saving all the materials automatically may be the most reliable way, which can be done given the technology we have. Nowadays, tracking and saving people's activity online (websites they visited, articles they read, video they watched, etc.) are being done by companies (e.g. Google, etc.) and governments (e.g. NSA), and without people's full consent in many cases. MICO can save all (or most of) the materials for the customers at their consent, so the customers do not need to do anything. At their consent, each MICO customer can have all the materials he or she read or watched online saved by MICO. These materials can be managed by customers, like downloading for safe keeping, deleting, or sharing.

In some embodiments, with the materials saved by MICO for the customers, MICO also can provide a powerful search tool for customers to find the material they want. Because the size this material can be huge after accumulation in years, simple keyword search is not sufficient. All the search starts with people's memory. People may or may not remember the keywords, but they may remember the year, month, day, or time; they may remember the place, the weather, or the device they used; they may remember a certain phone call came in, a certain email, text, or tweet showed up, or certain news happened at the time. All these information (memory) can be used by MICO to enable search. MICO not only can save the online activities (materials), it also can save the time and locations associated with the online activities. Based on time and locations, the weather information and important news happened around the time can be associated. MICO also can save ID of the device (laptop, mobile phone, tablet, etc.) used for the online activities, and the activities happened during the online activities (e.g. interrupted by reading/sending an email, text, or tweet; or answering a phone call). Therefore, MICO can offer a search tool that can use a lot of people's memories, such as time, location, weather, device used, memorable news or activities happened around the time, etc.

In some embodiments, MICO does not just save all the online activities (materials) in the same way, it can differentiate the online activities as important ones and not. MICO can detect the time customers spend on websites (e.g. how long they read the articles, or watched the video), and how active on the websites (e.g. number of clicks, scroll-downs). Through these detections, MICO can save customer's behaviors on websites, and rank some online activities as important and some as not important (e.g. a quick visit of a website). MICO can allow customers to select online activities as favorites, and highlight any portion of the materials. Customer's behaviors on websites (e.g. time spent, clicks, scroll-downs, etc.), MICO's rank of online activities, and customer's selection of favorites and highlights can all be used as searching tools.

It is to be understood that many other possible modifications and variations to various embodiments of the invention can be made without departing from the spirit and scope of the inventions as herein described.

While the invention is described with reference to the above drawings, the drawings are intended to be illustrative, and the invention contemplates other embodiments within the spirit of the invention.

1. A system for identifying an individual at an event whose face is at least partly shown in a particular digital image taken at the event, comprising:
a digital image module that electronically obtains, at one or more computers, an image, taken before or after the event, in which the face of the individual is at least partly shown, and metadata about the image, wherein the metadata comprises RFID data or barcode data uniquely associated with the individual and the image, wherein the RFID data is wirelessly obtained from an RFID tag worn or carried by the individual when the image is taken, or the barcode data is scanned from a barcode worn or carried by the individual when the image is taken;
a recognition module that electronically analyzes, at one or more computers, the particular image and the image, using software comprising a facial recognition technology or appearance recognition technology component, to obtain recognition result information regarding the individual; and
an identification module that electronically determines, at one or more computers, an identity of the individual based at least in part on (1) the RFID data or the barcode data uniquely associated with the individual and (2) the recognition result information.

2. The system of claim 1, wherein determining an identity of an individual comprises limiting determined or communicated identity information for security or privacy reasons.

3. The system of claim 1, wherein the RFID tags are passive.

4. The system of claim 1, wherein the image is taken at least in part for the purpose of facilitating identification of the individual in the particular image.

5. The system of claim 1, wherein use of each of (1) the RFID data uniquely associated with the individual and the image (2) the recognition result information contributes to the identification of the individual.

6. The system of claim 1, comprising identifying groups of individuals.

7. The system of claim 1, comprising utilizing group association.

8. The system of claim 1, comprising using image time and location metadata.

9. The system of claim 1, comprising utilizing GATE GPAR.

10. The system of claim 1, comprising wirelessly providing access or potential access to a certain image to an individual identified as being in the certain image, via a mobile device of the individual identified as being in the certain image, for purchase or potential purchase.

11. The system of claim 1, comprising uploading a certain image, with an individual identified as being in the certain image, to an account of the individual identified as being in the particular image, wherein the account is for an online platform allowing storage, organization and searching of memory- related, event-related digital materials.

12. The system of claim 1, wherein the event is a ride at an amusement park.

13. The system of claim 1, wherein the event is a wedding, party, ceremony, or company-sponsored activity.

14. A method for identifying an individual's image at an event, wherein the individual is at least partly shown in a particular image taken at the event, comprising:
electronically obtaining an image, taken on the same day as, and before or after, the event, in which the face of the individual is at least partly shown, and metadata about the image, wherein the metadata comprises RFID data or barcode data uniquely associated with the individual, wherein the RFID data is wirelessly obtained from an RFID tag worn or carried by the individual when the image is taken or the barcode data is scanned from a barcode carried by the individual when the image is taken;
electronically analyzing, at one or more computers, the particular image and the image, using software comprising an appearance recognition technology component, to obtain recognition result information regarding the individual; and
electronically determining an identity of the individual based at least in part on the RFID data or barcode data uniquely associated with the individual and the recognition result information.

15. A system for identifying an individual at an event who is least partly shown in a digital image taken at the event, comprising:
a digital image module that electronically obtains, at one or more computers, the image and metadata about the image, wherein the metadata comprises RFID data uniquely associated with the individual, wherein the RFID data is wirelessly obtained, from an RFID tag worn or carried by the individual at the event, when the image is taken;
a recognition module that electronically analyzes, at one or more computers, the image, using software comprising a facial recognition technology or appearance recognition technology component, to obtain recognition result information regarding the individual; and
an identification module that electronically determines, at one or more computers, an identity of the individual based at least in part on the RFID data uniquely associated with the individual and the recognition result information.

16. The system of claim 15, wherein wirelessly obtaining RFID data comprises using at least one of UWB RFID technology, SAW RFID technology, UHF frequency communications and microwave frequency communications.

17. The system of claim 15, wherein wirelessly obtaining RFID data comprises using at least one of a directional antenna, a smart antenna and a phased array antenna.

18. The system of claim 15, wherein wirelessly obtaining RFID data comprises using camera measurement of image objective distance and control of RFID power to control reading distance of RFID signal.

19. The system of claim 15, wherein wirelessly obtaining RFID data comprises using orientation and angle of RFID antennas to control RFID signal beam width.

20. A method for identifying an individual at an event whose face is at least partly shown in a digital image taken at the event, comprising:
electronically obtaining, at one or more computers, the image and metadata about the image, wherein the metadata comprises RFID data uniquely associated with the individual, wherein the RFID data is wirelessly obtained, from an RFID tag worn or carried by the individual at the event, during the period when the image is taken;
electronically analyzing, at one or more computers, the image, using software comprising an appearance recognition technology component, to obtain recognition result information regarding the individual; and
electronically determining, at one or more computers, an identity of the individual based at least in part on the RFID data uniquely associated with the individual and the facial recognition result information.
